(19) United States
(12) Patent Application Publication
(10) Pub. No.: US 2007/0244904 A1
(43) Pub. Date: Oct. 18, 2007

(54) Method and Architecture for Goal Oriented Applications, Configurations and Workflow Solutions on-the-Fly

(76) Inventor: Kristopher Durski, El Cerrito, CA (US)

Correspondence Address: REED SMITH, LLP, TWO EMBARCADERO CENTER, SUITE 2000, SAN FRANCISCO, CA, 94111, US

(21) Appl. No.: 11/419,474

(22) Filed: May 19, 2006

Related U.S. Application Data
(60) Provisional application No. 60/745,089, filed on Apr. 18, 2006.

(51) Int. Cl. G06F 17/30

(52) U.S. Cl. 707/10

(57) ABSTRACT

An architecture to deliver web applications to users that is comprised of links to virtual applications that are composed of physical applications (e.g., a software component with special rules). The web applications can be created, combined into larger applications and installed without the typical effort of writing and debugging software code. Building blocks are derived from a standard interface and rules including that none of the components call methods from any other component. The interfaces pass knowledge, and an agent basket holds properties of a job. Data needed to carry out tasks is found from resources other than the interface (e.g., database). Agencies actively monitor job postings (bulletin board posts) and call agents having a highest score for performing the job. Only active agents and components are maintained in computer memory and are killed when finished, minimizing system footprint and reducing hardware costs.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to Architectures and Methods for implementing goal oriented workflows and other solutions on-the-fly.

2. Discussion of Background

The field of Information Technology (IT) has many different systems, designs, and processes to implement various workflows. For example, Publisher—Subscriber, Peer-to-Peer or P2P, and Service Oriented Architecture, SOA are known processes. Publisher-Subscriber is taught in schools, Peer-to-Peer or P2P, is a dedicated to network architecture and Internet messaging and file sharing, and SOA dictates that the publisher tells the subscriber what to do. Components are services that get hardwired into various pipelines to implement business objectives.

Available systems include a middleware layer called ESB, Enterprise Service Bus. Other systems also define SOA as an enterprise-wide re-engineering of the whole company. Together, they require a reanalysis of the organization and a new abstraction of all processes. The organization is put back together in SOA, where the more abstract components are available to business managers to reconfigure functions such as CRM, Customer Resource Management. Some also propose a conjunction of technology between SOA and CRM. However, for all its flexibility, SOA remains a deterministic implementation of processes.

Despite a number of varying technologies, today's systems are not efficient and truly user friendly for developing new or modified processes.

### SUMMARY OF THE INVENTION

KDH Systems has invented a new method and architecture to deliver web applications to users that is comprised of links to virtual applications that are composed of physical applications (a software component with special rules). KDH web applications can be created, combined into larger applications and installed without the typical effort of writing and debugging software code.

Users interact with only the KDH virtual applications. The virtual applications are easily extensible without recoding any of the existing physical applications. KDH web applications provide a GUI (Graphic User Interface) for system functionality built around software agents and web services. Software agents are the core of system business logic while web services provide remote access to them. However, some of the web services also provide business logic for functions that can be executed immediately and don't require waiting for results such as local database queries. (See Agent Workflow Architecture discussed further below).

KDH physical applications are fairly small to ensure simplicity and manageability. A new physical application can be added by linking to other physical applications without changing code. Physical applications can be shared by many virtual applications. Users do not see the physical applications.

Motivation for the invention includes the desire to realize a truly digital hospital, however the technologies described by the present invention have wide reaching applicability to many other professional and non-professional organizations. With other more general applications in mind, and the digital hospital in particular, most systems developers focus on the traditional methods of workflow and programming to implement the workflow. KDH Systems' position is that the message is not about workflow itself or expensive programmers. Simply put, many systems, and healthcare in particular, are unique at every level of its operations and it varies from institution to institution.

It is unknown what the ideal Health IT model should be since it is dynamic and changes before people can define it. That is because the medicine itself is dynamic. A great variety of medical equipment from imaging to lab robots just adds complexity to this environment. The point is to build a small adjustable system that solves only local problems but can see the rest of the world. Same as in LEGO blocks. There are only a very small number of different blocks that can be connected in countless of ways, but once connected become part of even big machine or system. Smaller pieces are easier to build and manage, and in case of failure affect only a small area of activity. If those pieces are flexible enough specialized mutations can easily be built, just as specialized LEGO blocks, which continue to fit to the entire system. Even if the user has to build something special and use expensive programmers, the user is not rebuilding the entire system or creating complexity that goes out of financial control. The user is building yet another building block that will not only fit a single hospital but also the rest of healthcare, although they all may have different system configurations. That's the fundamental concept behind KDH's Goal Oriented Architecture and each of the fundamental processes and systems described herein are support that concept.

Some enterprises have noticed that interoperability is the key to resolve the issue of inevitable multi-vendor presence in one medical institution. However, they generally miss the point that all information has to be managed by one system, or every system has to be told about the rest of the environment. The second is an IT nightmare. That's why they prefer web based systems with a gigantic database, but then they ran into the inflexibility problem, which is a killer in healthcare—“one tool does everything” has not proven to be a viable solution.

As opposed to that, the present invention includes the use of a bulletin board for skill and job request posting. If a new system is added or changed it posts its skills on the bulletin board and becomes visible to the rest of the systems without their reconfiguration. Common languages like HL7 or DICOM still require that every end user system knows about the rest of the world or one big system has to manage all the data. It leads to a vicious circle. Yahoo or Google provide examples of information bulletin boards, but they falter in providing services on demand. In one embodiment, our bulletin boards provide services on demand but no information sharing, so they can be much smaller and do much more. The user can always obtain information if the user can find service that can do it for the user. The user can do more with that system because some services can do data processing the way the user specifies, hunt for a specific information, and notify the user when that information is available.

The KDH model is also better than the current Internet search engine model for information hunters. However, web services do generally have a need to be found in order to use them. In our model the service has to find the user by posting skills in a visible way. For example, when the user post's a request the search engine matches both and passes the user's request to the service, which in turn passes results back to the user. It is simpler and more reliable, and easier to manage, resulting in increased user satisfaction across a larger range of users. The invention distributes intelligence and linking through a limited number of agencies.

The present invention is described in two parts, including discussion related to Web Applications which is a comprehensive description of KDH's new method of building applications without coding, including an express description of unique features and content for a variety of items, and authentication including a unique use for tokens. Discussion related to Agent Workflow Architecture relates to a back end operation of what is termed a Goal Oriented Architecture.

The entire disclosure includes, for example, any one or more of a self-organizing system for matching agents and job postings; Product extensions and upgrades without added complexity or debugging; Loosely-coupled component interfaces without direct mapping between publisher and subscriber; Connecting components without scripting, which enables anyone to build applications and workflows; Create virtual web applications with dynamic linking without coding; Support for continuous improvement in customer productivity and satisfaction; Provision of individually customized web pages with dynamic linking; a system where users can extend virtual applications and receive personalized web pages based on login credentials and objective; and Secure Authentication with Tokens built into forms, including, for example, and one or more of: All forms are authenticated—no exceptions, Administrator can invalidate all tokens instantaneously to block intrusion, Token contains system ID or cluster ID to block spoofing, and no browser certificates needed.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration of a web application website according to an embodiment of the present invention;

FIG. 2 is an illustration of a typical physical web application and its structure;

FIG. 3 is a diagram of a Page flow control process according to an embodiment of the present invention;

FIG. 4 is an example of directory structures of web applications and web services according to an embodiment of the present invention;

FIG. 5 is a drawing of an example virtual application and customization table tree according to an embodiment of the present invention;

FIG. 6 is a drawing of an example virtual application and data flow according to an embodiment of the present invention;

FIG. 7 is a drawing of an example Application linking according to an embodiment of the present invention;

FIG. 8 is a drawing of an example of a root application with item list and form selection menu according to an embodiment of the present invention;

FIG. 9 is a drawing of an example of a root application with form selection menu according to an embodiment of the present invention;

FIG. 10 is an example Data collection application according to an embodiment of the present invention;

FIG. 11 is an example of Node overloading according to an embodiment of the present invention;

FIG. 12 is an example of personalization according to an embodiment of the present invention;

FIG. 13 is an example of user or form token lifecycle according to an embodiment of the present invention;

FIG. 14A is an example of an Application Property basket according to an embodiment of the present invention;

FIG. 14B is an example of an Agent property basket according to an embodiment of the present invention;

FIG. 15 is an example of mapping icons to data values according to an embodiment of the present invention;

FIG. 16 is an example system architecture according to an embodiment of the present invention;

FIG. 17 is an example Job posting bulletin board according to an embodiment of the present invention;

FIG. 18 is an example Skill posting bulletin board according to an embodiment of the present invention;

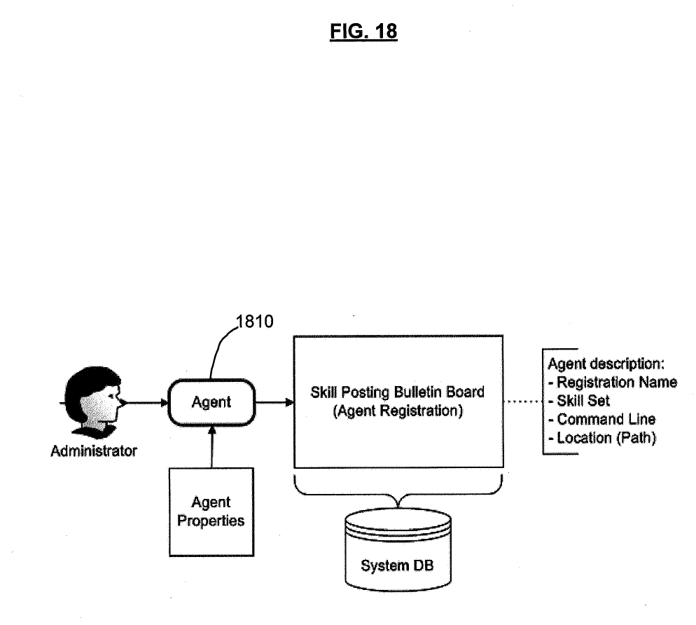

FIG. 19 is an illustration of an example Job request handling according to an embodiment of the present invention;

FIG. 20 is an example Invocation of an agent and execution process according to an embodiment of the present invention;

FIG. 21 is an example of service parameters according to an embodiment of the present invention;

FIG. 22 is an example of command lines according to an embodiment of the present invention;

FIG. 23 is an example of service data according to an embodiment of the present invention;

FIG. 24 is an example of a data broker according to an embodiment of the present invention;

FIG. 25 is an example passport exchange between local and remote systems according to an embodiment of the present invention;

FIG. 26 is an example workflow according to an embodiment of the present invention;

FIG. 27 is an example workflow process according to an embodiment of the present invention;

FIG. 28 is an example Monitor according to an embodiment of the present invention;

FIG. 29 is an example Workflow database structure according to an embodiment of the present invention;

FIG. 30 is an example of service parameters according to an embodiment of the present invention;

FIG. 31 is an example of workflow step details according to an embodiment of the present invention;

FIG. 32 is an example data broker environment according to an embodiment of the present invention; and

FIG. 33 is a flow chart illustrating an example agent workflow according to an embodiment of the present invention.

### DESCRIPTION OF THE PREFERRED EMBODIMENTS

The present invention, generally described as KDH technology, is a new design pattern that incorporated portions of prior design patterns into something completely different. One of several ways that the described technology departs from the ESB & SOA models is by scale. KDH technology can be used at the level of the individual physician, physician practice or hospital department. Our enterprise solution is a collection of departments each using their own autonomous KDH workflow systems that comply with the business rules of the overarching enterprise. Of course those business rules could be implemented into a new enterprise workflow based on our technology.

One frequently mentioned advantage of SOA is a modeling process that turns the model into program with great ease and clarity of purpose. We have the same potential to define and implement new applications while preserving the individualized customization by user, by department, etc.

The model of KDH Technology is not to replace programming in enterprise or health IT, but to eliminate scripting from the user side and enable applications and workflows to be built on the fly by the users. We have a new paradigm in the concept of our “workbasket” and a new way to implement the operation of bulletin boards.

KDH's use of Building Blocks is another departure. The lowest level building block is a new class of component with unique characteristics: They are complete applications and have a standardized interface. None of the components can call a method from any other component. Components do not connect directly to other components.

A second level of building blocks is a unique class of agents with the following characteristics: proactivity and intelligence. These agents do not communicate directly with each other and they do not instruct each other.

Our components and agents are considered peers. Communications are considered peer to peer. The fundamental innovation is that none of these components and agents has a client-server or master-slave relationship. The difference between our components and agents may seem somewhat arbitrary, but it is useful to keep track of their scope of operation. Also, one should not be confused by the fact that they are built of ordinary software tools such as COM components, web services and .NET objects.

The third level of building blocks is the KDH agency. Agencies are delivery services that start KDH agents.

Another departure is found in KDH's Interfaces. Ordinary component interfaces pass knowledge. Our component interface passes the workbasket. We have an agent basket that contains an XML standard object to hold the properties of a job. We also have a forms workbasket that uses a proprietary format to hold the properties of the form. These baskets are another object of the patent.

The agent basket is held in a database table and the forms basket is stored in the form so its contents are displayed in the browser. When the form is submitted, the basket is put into HTTP Context (encrypted) and transfers control to the next form. There is a form manager that links the path to the next form.

All KDH components, agents and forms are linked through a Bulletin Board that's divided into three aspects: job request, skill posting, and form linking. This bulletin board utilization is an object of the patent.

A job request may come from forms, agents and components. Components and agents post their skills on the skills board. Agencies are actively monitoring job posting and calling agents that have the highest score for performing the job. This method minimizes the KDH software footprint; because only active agents and components reside in computer memory and they are killed automatically when finished. This technique provides minimal hardware cost and is another object of the patent.

Yet another departure is found in KDH's Front-end architecture. Forms represent the user-side or macro-scale operations. Forms are connected to the bulletin board via the KDH form manager (DataAccess.dll) that contains most of the business logic for a given installation such as user authentication, form authentication, interfaces to other databases, form mapping and personalization, graphical element mapping and hundreds of other methods.

Forms call on the form manager when it is time to move the application or process to the next stage. The forms manager puts the workbasket on the bulletin board and calls the next form. That form is responsible for getting the basket and using its contents, and is another example of self-organization.

KDH forms are built in a proprietary process combining graphical elements, embedded code, attached components (precompiled objects) and client-side scripts. Forms on the server perform the majority of the computation using the full range of KDH agents and components. The server side forms are responsible for constructing the GUI (graphical user interface) and sending it to the client-side browser. Some additional business logic may be placed in client-side forms but only for the purpose of rapid response to the user.

Form linking is determined by the user and this gives the user the power to define processes on the fly without the need for scripting or any other software skill. The exact user interface for linking forms has not yet been designed, but there are many models available such as Microsoft Visio or Macromedia Dreamweaver that are available for the rapid modeling and implementation of new applications.

And yet another departure is KDH's Goal Oriented Processes. Both front end and back end components realize individual and global goals. Individual goals are achieved through a hard coded or configurable process encapsulated in a particular component, such as ED chart, case selection, printing, data export, remote query, etc. Although these seem like typical services, they are achieved in a very different way.

Service components react to client method calls and the resulting success or failure is handled by the client. Goal oriented components take full responsibility for their jobs. Instead of method calls, they accept a request for a service or job and carry it through the entire process. Any responses to success or failure are handled internally by the component, though they can be overridden by a workflow links.

Global goals are realized through links between components. In many cases, front end components also involve back end components to achieve their goals. Front end components are linked into applications that are oriented towards user goals, e.g. organize data collection, organize data mining, request remote query, etc. Back end components are linked into ad hoc background workflows that extend front end applications, e.g. track reports, track lab orders, perform remote query, etc.

The workbasket comes into play as a unique method that enables components to contribute to a process according to the information available, to further the process when more information arrives and to give persistence to the process until the job is done.

Each component has the ability to interrogate the environment such as databases, files and registry to acquire all necessary information to achieve its goals. What the property basket carries is the job description such as subject index, print format, email address, user ID, etc. The property basket also needs to carry hints as to what should be done. The rest is configured in skill posting.

This model is possible because each component is expected to realize its own goal from start to finish, meaning it produces results that can be stored back to the environment and used by other components. Results may redirect the path automatically by initiating a new workflow and is another example of self-organization. Data are available through environment, so confidential information is not passed between components.

The property basket can be expanded, for example, with the addition of new components. The property basket provides a single standardized interface from which knowledge is transferred. The conditions of a query (e.g., used to retrieve data) is knowledge.

The KDH Goal Oriented Architecture comprises two distinct architectures that are nowhere else described in the software industry. One is the back end or “Agent Workflow Architecture,” and the other is the front end architecture. Together, they provide the facilities to build and revise applications while KDH engineers can extend functionality by building new agents and components that comport with the KDH internal interface specification. Publishing the KDH internal interface specification will have the effect of creating an Open Architecture for customers, consultants and others to create extensions and new functions that enhance the commercial viability of this technology. Subsequent posting of new agent skills on the bulletin board brings its functionality into play as needed with no need to question the integrity of the whole system or perform and degree of QA testing and risk analysis.

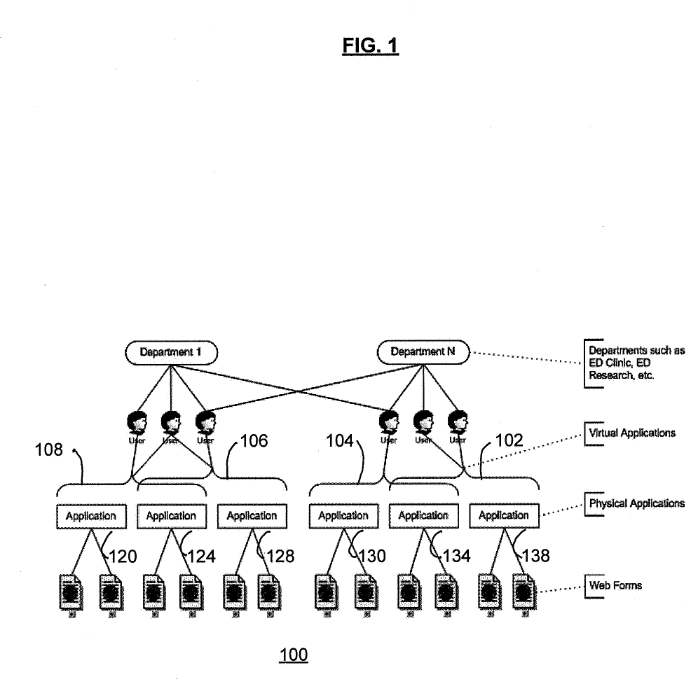

Referring now to the drawings, wherein like reference numerals designate identical or corresponding parts, and more particularly to FIG. 1 thereof, there is illustrated a web application website 100 according to an embodiment of the present invention. A department is a group of users (e.g. Dept. 1 . . . Dept N) and virtual applications that serve a specific purpose, such as emergency department clinical work, emergency department research, billing, clerical, administrative, etc. A virtual application (100) consists of a mapping of multiple physical applications (110) under a single name called “application name”. For example, virtual applications 102 is a mapping of physical applications 134 and 138. A physical application is generally a special purpose component. Forms, on the other hand, are a higher level of applications and can be for example, a single form or a collection of forms (120) to perform specific tasks, such as research study or clinical examination.

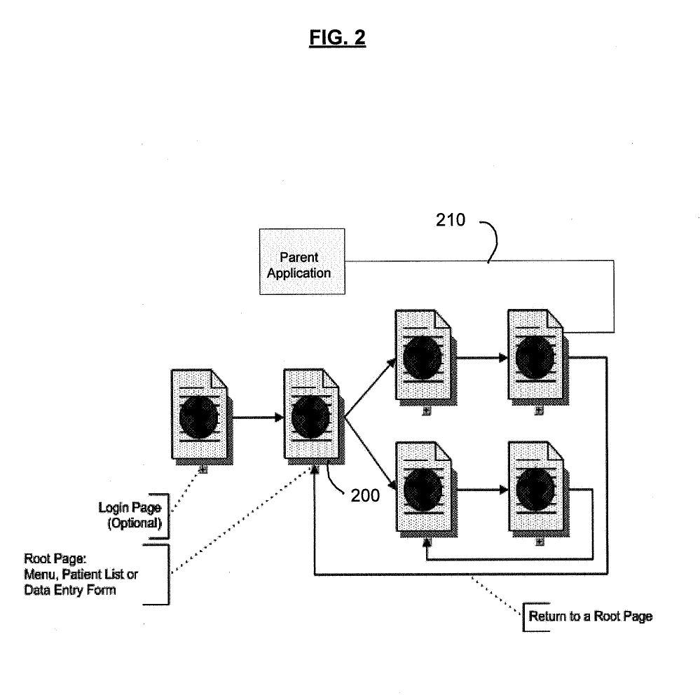

Linking between physical applications within one virtual application (100) is achieved by mapping forms and return actions. FIG. 2 is an illustration of a typical physical web application and its structure. Each physical application should have a root entry (200) to which it returns through return action (210). Linking 210 bypasses the root entry, so return (220) takes the application to the parent application rather than to its own root. Physical applications that are not intended to perform functions as standalone applications do not need to have a root page implemented, but they have to implement a return to its virtual root.

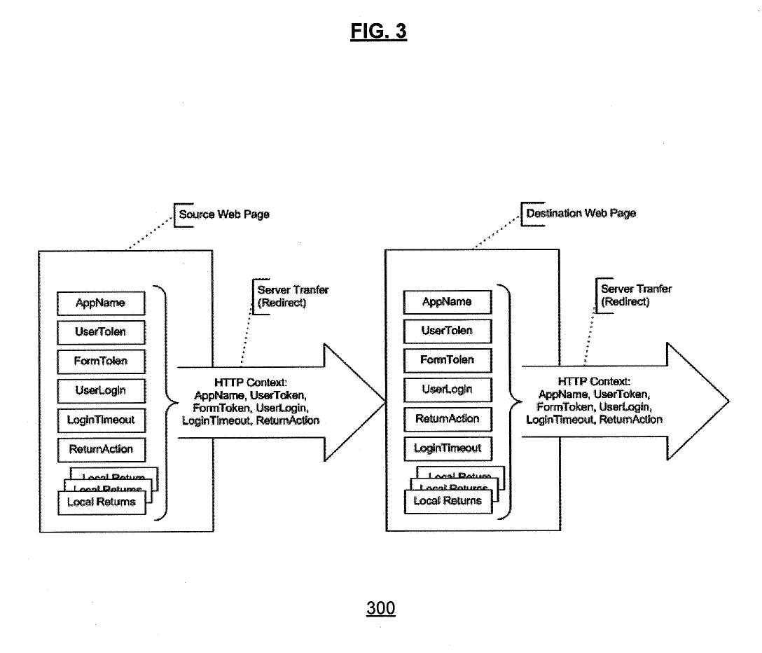

FIG. 3 is a diagram of a Page flow control process according to an embodiment of the present invention. Each page within a physical application implements the following fields and their handling mechanism. In one embodiment, each field must be implemented:

TABLE 1
Required Properties of a Physical Application

KDHAppName - ensures mapping within a specific scope
KDHUserToken - allows for user auto-login
KDHFormToken - allows form authentication (virtual user)
KDHUserLogin - after login timeout a user has to be prompted to login
KDHLoginTimeOut - the time after which user token expires
KDHReturnAction - a path to the parent application such as main menu,
etc.
Selection items or index, e.g. MRN, VisitID, StudyID, etc.

For exchange between forms those fields are packaged, for example, with:

Public Function SetKDHStatus(ByVal fldArr( ) As String) As String where fldArr( ) is an array of pairs (name, value). The receiving form should use, for example:

Public Function GetKDHStatus(ByVal kdhStatus As String, ByVal nameArr( ) As String) As String( )

to retrieve the desired fields by passing nameArr( ) with their names.

In addition, pages may also implement local returns for use of the same page in multiple locations within an application tree, but this is up to the application developer. The KDHReturnAction path can be used explicitly by presenting it to the user as a menu item, e.g. Main Menu or implicitly if an application does not implement looping.

Directory Structure

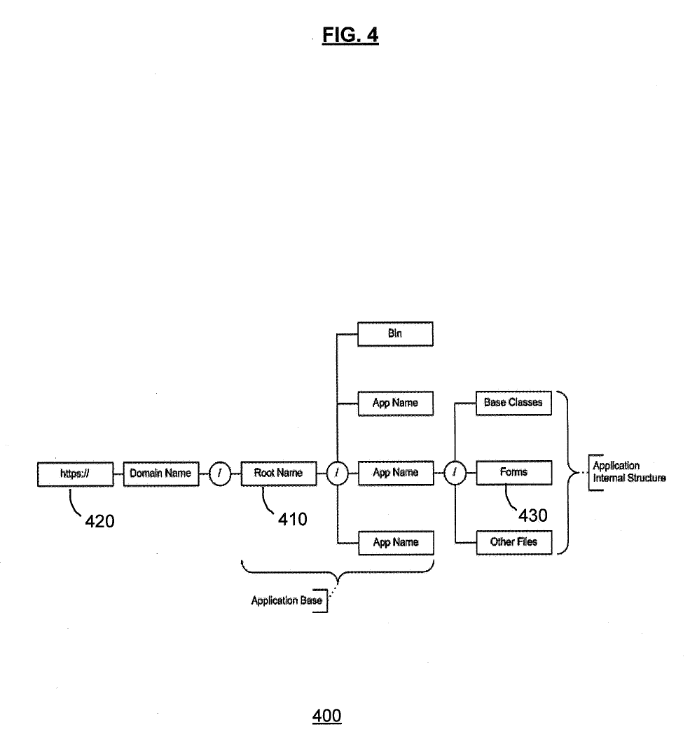

FIG. 4 is an example of directory structure 400 of web applications and web services according to an embodiment of the present invention.

FIG. 4 provides example locations of applications on a system. Physical applications and web services are visible through virtual directories of an IIS web server. They can be physically located anywhere and are linked to a virtual root (e.g. linked to C:/Inetpub/wwwroot). Applications can be located in their own root directories, (e.g. Root 410) but their dlls are added to a GAC (Global Assembly Cache, not shown) to be visible to all other applications for linking purposes. In addition to GAC, each application uses the same validation key as if they were running on cluster servers set in the Web.config file. For example:

<machineKey
validationKey=“B3D50FACFED6C2F575192E0EEA0B10DFE2167470F73731B069C5
C6FDD0C4648B6CC20DC663766C4345B5F41E6F24AB721F1D9E6CFB9F6858812F
758A5C06C7BF”
decryptionKey=“541B004800ED428FCD45FD47C06E27D731F9DA8CD29F2614”
validation=“SHA1” />

In one embodiment, all applications share the same bin directory, but they are stored off the same root, e.g. https://domain/KDHSystems. Then, each application can be accessed through the web with, for example:

https://domain/KDHSystems/AppName/Default.aspx (420)

URL or directly to an ASPX form

https://domain/KDHSystems/AppName/Forms/FormName.aspx.

The directory “Forms” is not mandatory but can have any name (430).

Mapping Tables

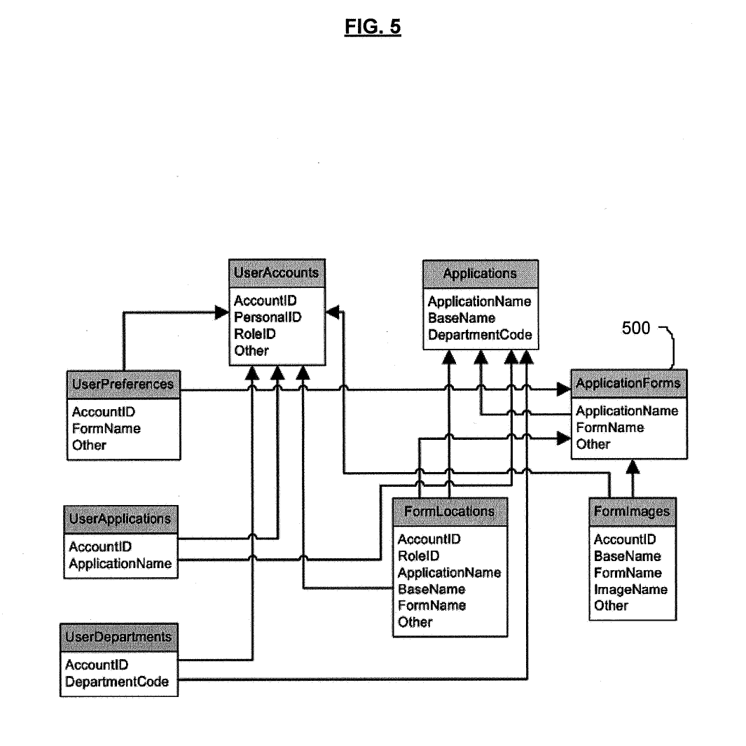

Virtual applications are collections of links to physical applications rather than directly connected single forms to reduce the complexity of linking. In that concept, a physical web application becomes a pluggable component of a larger application. The heart of control lives in DataAccess.cDataAccess module and UserAccounts.mdb database. FIG. 5 is a drawing of an example virtual application and customization table tree according to an embodiment of the present invention. FIG. 5 is a partial view of a database. The complexity of this database is encapsulated in DataAccess.dll. The ApplicationForms table (500) provides registration of entry points to specific applications. Its records can be filtered based on ApplicationName, which is the name of a virtual application that is cached in KDHAppName. In one embodiment, there are three ways of launching virtual applications:

Desktop icon where target is as follows:

“C:\Program Files\Internet Explorer\IEXPLORE.EXE”

“https://domain/KDHSystems/AppName/Form.aspx?KDHAppName=Name”

Web Menu Item

Set KDHAppName to the required virtual name

Server.Transfert(FormName.aspx)

Dedicated form with hard coded virtual name

Applications and Forms

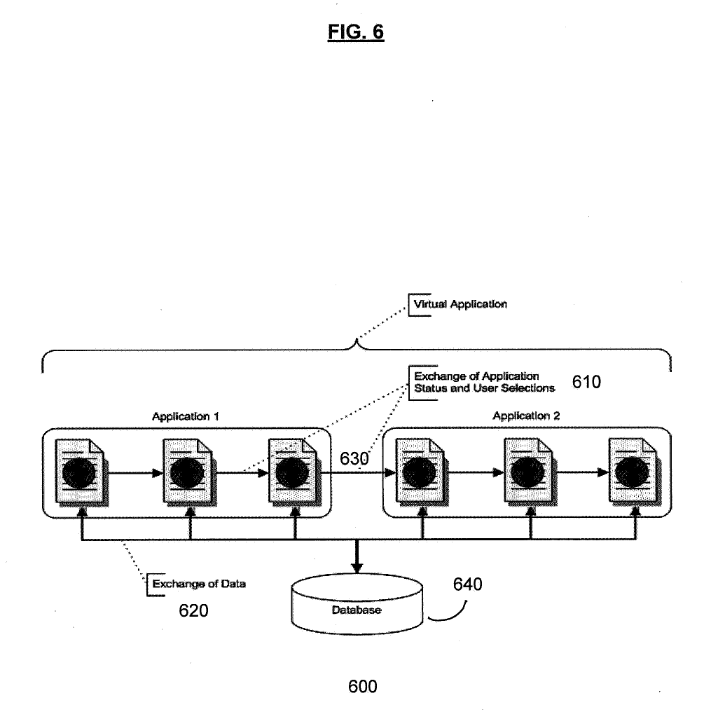

A linked collection of physical applications is called here a virtual application. A collection of linked forms stored in the same directory is called a physical application. FIG. 6 is a drawing of an example virtual application and data flow according (600) to an embodiment of the present invention. Each form in this architecture is a pluggable component that has to support status (610) and data exchange (620). Application status such as application name, user credentials or selected subject, etc. are passed from form to form through HTTP context (630). Data to be displayed or processed are passed through a database (640). Each form is an application by itself that carries a task from the beginning to an end, so the results can be stored on a database or at least cached within the scope of a physical application, but not beyond.

Each physical application is a standalone unit that can carry out a set of tasks from start to completion. A connection between physical applications may bypass subject selection, but should not disrupt the processing and storing results. A physical application must have clearly defined entry and exit points. An interface between forms should follow the rule: send to the output as much as you know and take from the input as much as you need. The vocabulary of application status has to be well defined, but it is limited to only a few items where an example definition is provided later in this document. The data items should be handled through a data broker, which translates form vocabularies into database schemas and field names making forms portable with slight installation overhead in setting up the vocabulary. The data broker provides fuzzy matching of data items to make the installation more automated and reduce overall installation time.

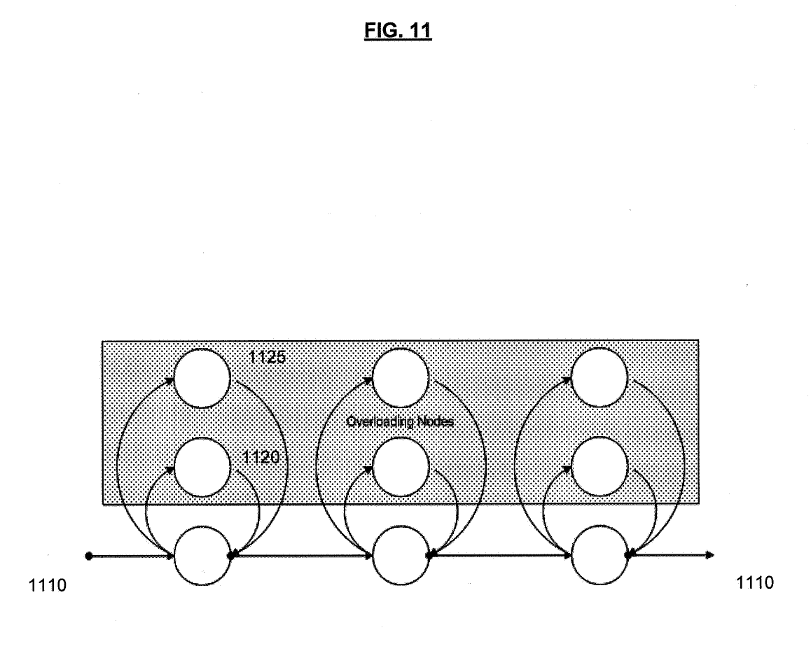

Applications and forms link works as function overloading. For example, FIG. 11 illustrates one form of overloading. Functionality of the overloading is similar to that in C++, C# or VB, where a call goes to a function different from the prototype function The function, which parameters match the sequence of parameter types in a function call, is included in the program.

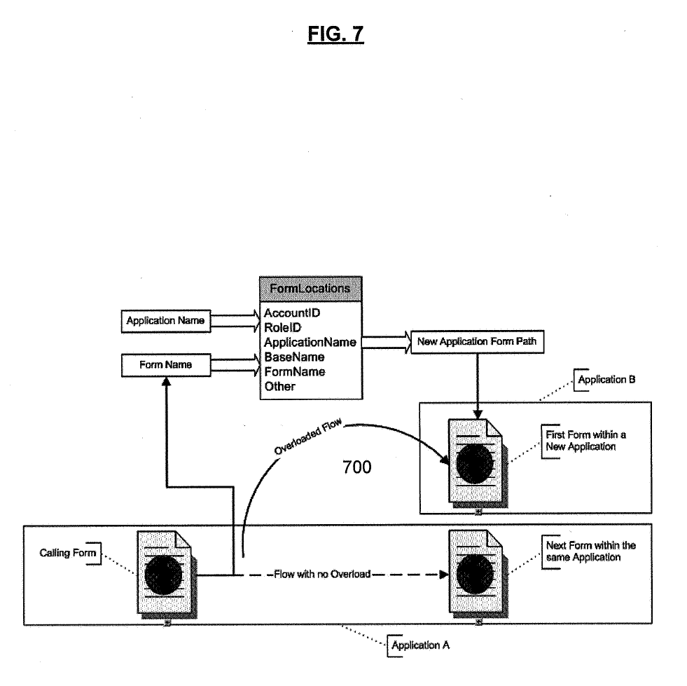

With applications linking, overload (700) happens if parameter values match a specific record that defines form locations. FIG. 7 illustrates an example Application linking according to an embodiment of the present invention. Virtual applications can be quickly built by linking multiple physical applications. Each physical application should provide a description of entries and exits to facilitate the operation of an application builder. On the entry side, the description should list all forms that can be entered and their input parameters. This includes mandatory requirements for all forms and specific requirements that must be implemented for the form to do its job. On the exit side the description should list all forms that can be overloaded as outputs and the results they produce other than mandatory fields.

KDH applications and forms can be subdivided into several distinct classes (see Table 2):

TABLE 2
Classes of Forms

Login - forms as entry points to virtual applications
Menu - forms that are registered entries to physical applications displaying
dynamic lists of physical applications assigned to a virtual application.
Listing - forms that are used by menu forms to list items prior to entering
a specific physical application
General - back-office and other admin
Research - applications, which purpose is data collection, data mining,
data management, etc. for research purposes
Clinic - same as above, but for clinical purposes

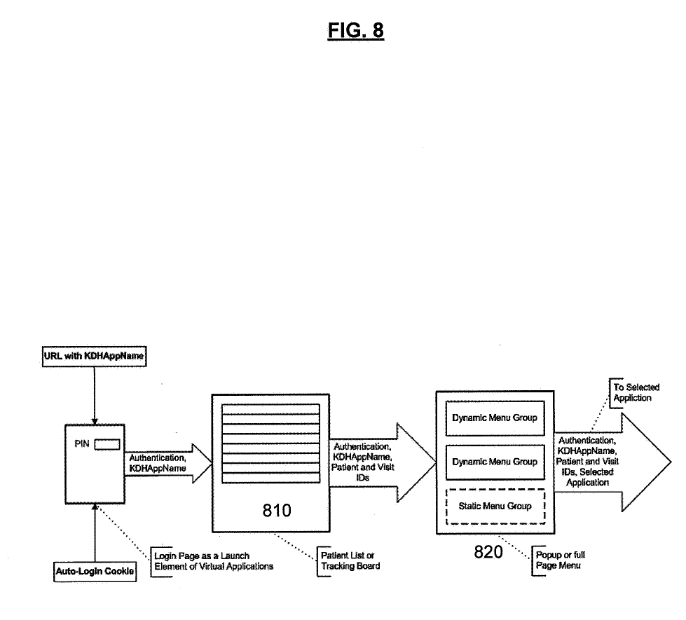

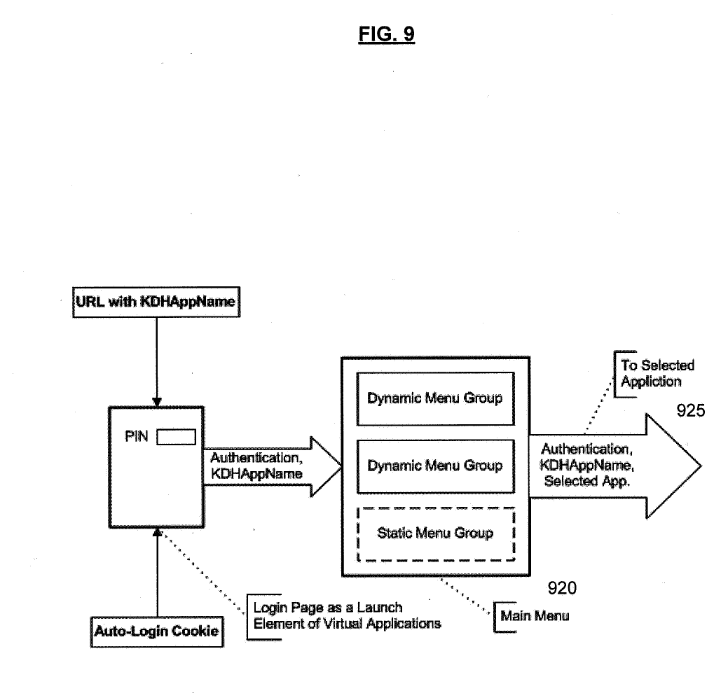

In general, clinical and/or research virtual applications start in two ways:
Item (patient, users, etc.) list first and then go to a form selection menu, which could be overloaded with direct link to a data collection application. For example, FIG. 8 is an example of a root application with item list 810 and form selection menu 820 according to an embodiment of the present invention.
Menu selection first and then go to data collection applications. For example, FIG. 9 is an example of a root application with a main menu 920 for menu selection. Upon menu selection the appropriate application is invoked 925.

In both cases, menu selection pages are dynamically generated based on configuration data of a virtual application. The same module should be reusable in various applications, by overloading listing pages. The item list page, for example, applies filtering that targets a specific user or group of users rather than a specific form. A work list is presented of that group or user. Other conditions are provided to narrow the scope of listing.

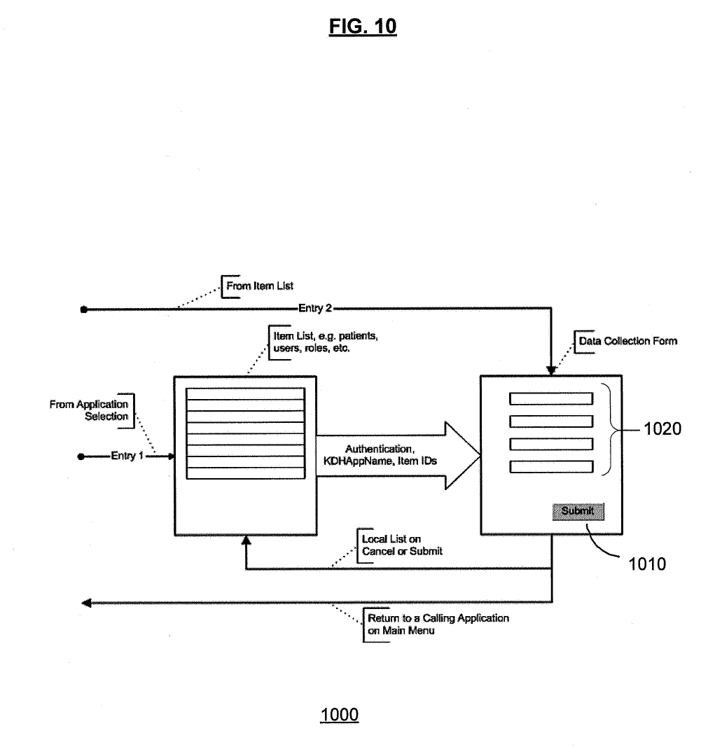

An output from a root application is passed to one of the entries of a data collection application. For example, FIG. 10 is an example data collection application 1000. A data collection application allows for looping between data collection forms and a data listing forms. In addition, forms should include a menu item to return to (e.g., submit 1010) the calling application. A label of that button or link should also be configurable to reflect its real function.

A list in a data collection application (e.g. item list 1020) should apply filtering that targets a specific form or goal of an application. It may also include a user or other conditions implemented by the designer. Such filtering and other conditions should be sufficient to assure selected items are relevant and within range of the corresponding application.

Personalization

Personalization uses the same mechanism as application linking based on form overloading. For example, FIG. 11 shows an example of Node overloading in a flow 1110 according to an embodiment of the present invention. For example, the first node on flow 1110 is overloaded by either of nodes 1120 and 1125.

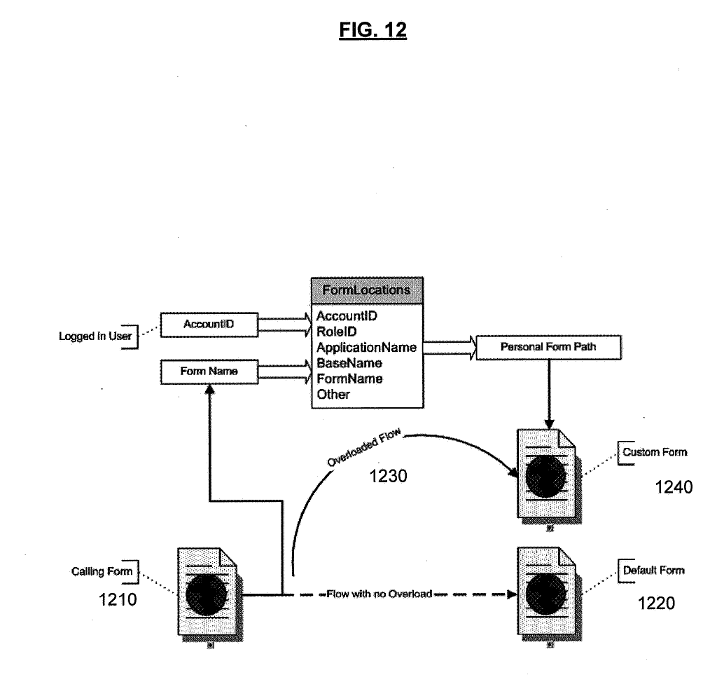

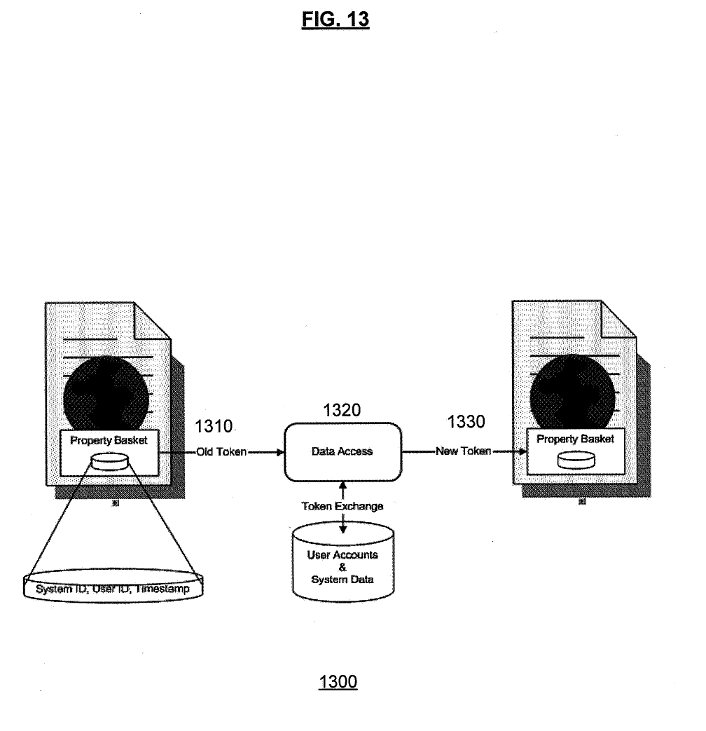

With personalization, overload happens if parameter values match a specific record that is defined in FormLocations table. For example, FIG. 12 illustrates personalization in a calling form 1210 which invokes a default form 1220 which is then overloaded 1230 to a customized form 1240 of the default form. In FIG. 12. matching is shown. Matching is performed, for example, by the DataAccess.cDataAccess component using specific contributes of an application content (e.g. see FIG. 13, 1320)

However, it is important to remember that when linking pages this base will be relevant to the source page (current) rather than the destination page. Therefore, the base is for example, retrieved from the linking database (linking it to the destination

The present invention includes several types of personalization; for example, per user, per role and default or for all users without personalization. Each type may have no scope, physical application scope and virtual application scope. Although personalization in general should overload a single form if derived from a default form, it can be modified such that the further flow can also change or overload the default flow. However, such customization should be practiced with great caution, because the default flow would no longer guarantee the application flow unless the control would overload several forms in the same application thread.

Form Authentication

Each form must implement login verification before proceeding to any data retrieval or initialization. Login verification is performed, for example, with:

Public Function VerifyUserLogin(ByRef token As String, ByVal usrLogin As String, ByRef accID As String, ByRef roleID As String, ByRef roleCodes As String, ByRef usrName As String) As Integer

that returns a new token if old token was valid or user new login was correct. It also returns user attributes needed for role based form initialization and rendering. If the form does not require user permissions (general purpose form) the following authentication may be utilized:

Public Function VerifyFormToken(ByRef token As String) As Integer a general purpose token that can be obtained with:

Public Function GetFormToken(Optional ByVal autoLogin As Boolean=False) As String

In one embodiment, every time the token is verified a new one is returned with a new validity time. By default a token expires, for example, after 10 minutes. Within that time period the token has to be renewed by verification or new login credentials will have to be provided. It's most friendly to the user if the currently displayed form checks the expiration time and pops up a login dialog prior to submitting data or transferring to a new form. In one embodiment the DataAccess component gives the server about 2 minutes longer timeout to ensure that submitted valid token doesn't get lost in server side processing time. When the token is considered by a form as expired and pops up a login dialog, the token has still about two minutes. That overlap provides for a smooth transition of credentials thus eliminating unauthorized access errors.

For example, see FIG. 13 that illustrates an example token lifecycle 1300. Each form that requires a valid user login maintains the user token (1310) without re-login and allow all operations within the form. for example, see FIG. 13 that illustrates an example token lifecycle. (e.g. FIG. 13 also shows Data Access 1320 checking validity of the user and returning a new token 1330). If a form connection link is called, such as cancel, submit, etc., it checks the token timeout and if expired, the form should pop up login dialog. After receiving new login credentials it should verify them to obtain a new token. On failure, it should pop up a login failure dialog rather than re-referencing to a login failure page to prevent loss of data that were entered into that form. Login verification is performed by the source form that holds the expired token to avoid a denial of destination form and a break in the flow of the application resulting in loss of entered data. It is desired that the destination form behave in a friendly way and pop up a login dialog if the current token is missing or expired instead of denial pop up. That mechanism should be built in to every form that requires user credentials. General purpose forms that do not need user authentication still require a form token that identifies it with the server or server group. Expiration of that token, which is much longer than user token, will require user credentials to renew it.

Form Status

Each form is responsible for maintaining the status, which has three levels:

Virtual application specific

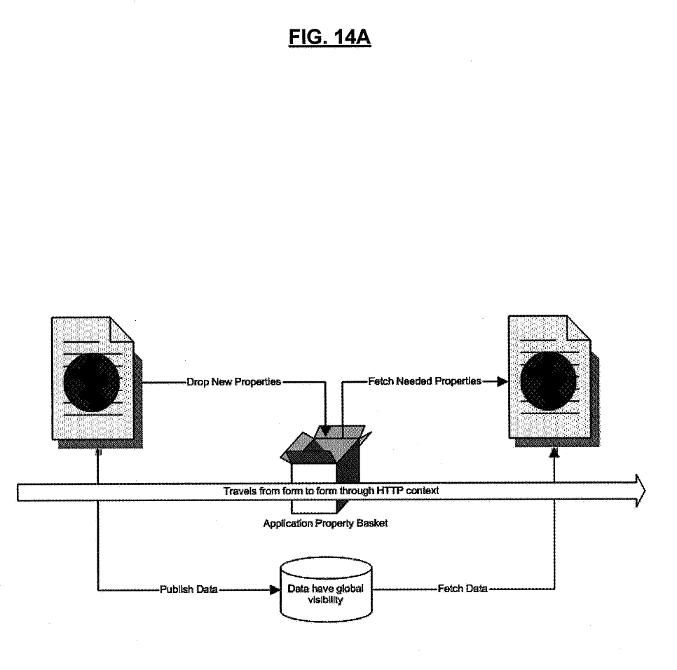

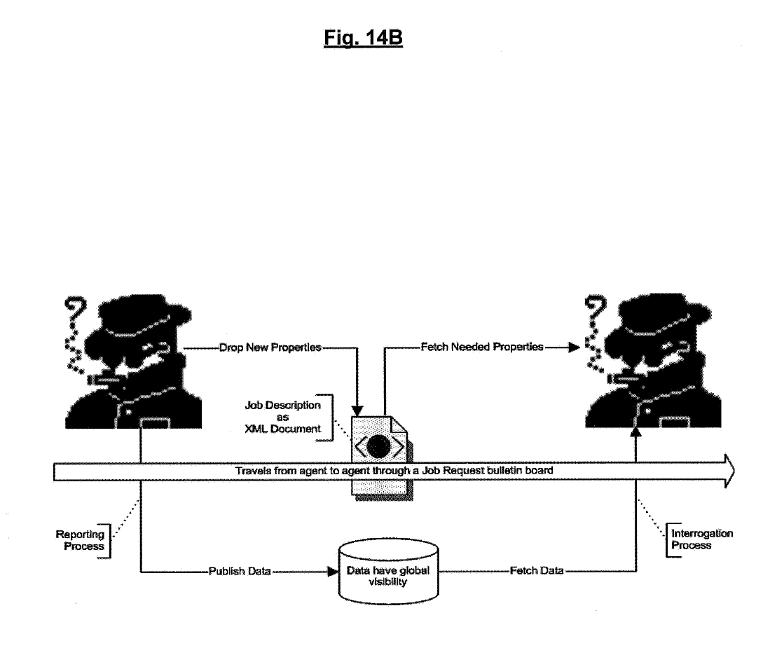

Virtual application name—AppName
A link to the main decision point within a virtual application such as main menu or item list—ReturnAction. For simplicity there should be one return action per virtual application. A return action is activated when the user selects a link or button submit, done, or main menu, depending on the required flow
Selection items or index such as database index fields, e.g. MRN, VisitID, StudyID, NotifierID, etc.
Results that are not stored in a database that might be used by other forms are stored in the property basket. (See FIG. 14A, Property Basket and FIG. 14B Agent Properties Basket

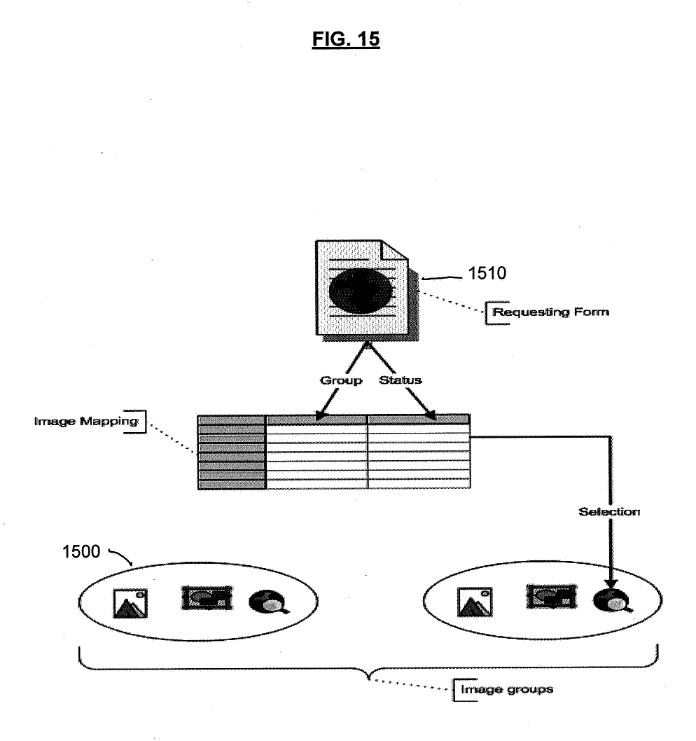

Physical application specific
A link to the main decision point within a physical application such as main menu or item list—LoopAction. There may be several loop actions within a single physical application, but it should be minimized to a small number preferably one to ensure simplicity of operation. A loop action is activated when the user selects a link or button submit, or cancel, depending on the required flow
Global scope IDs: MRN, VisitID, StudyID, VisitDate—visible throughout a virtual application until a new selection is made that overrides previous selection
Local scope IDs—not visible beyond physical application and specific to that application
   Form specific
User authentication token—UserToken. This token has global scope but is unique to each form, since each form performs re-login.
Form authentication token—FormToken. Same as above, but used if no specific user rights are required to enter the form.
User login that is used to re-login the user after token timeout is reached—UserLogin
Token timeout received by each form after verification of user token—TokenTimeOut
   Form Content
As shown in FIG. 15, various situations medical content is presented in the form of icons (1500) for better visibility. It is important to symbolize the same entity in the same condition in exactly the same way in all applications to avoid confusion. Any hard coded links would make form not portable due to site preferences in symbolizing things. Also, any changes in those preferences would require recoding forms (1510). To avoid this issue a mapping facility of a DataAccess component should be used.
   Agent Workflow Architecture

Rising IT costs and growing demands for reliability and security of healthcare computer information systems render many IT options prohibitively expensive. Contrary to the need in areas such as emergency medicine, where the 24×7 operation model has the greatest demand for IT support, the funding is usually the smallest. Regardless of a medical specialty or the size of a practice, from a single practitioner to a large clinic or hospital, interruptions in healthcare IT services usually lead to disruptions in patient services, which is not acceptable ethically and legally. Paper and pencil can temporarily relieve the problem, but reentering data back to a system adds cost and is prone to additional human errors and significant delays. Besides the reliability and security requirements, healthcare is under continuous evolution in terms of knowledge and methodology. Hundreds of new treatments and new medications are introduced annually. Due to a slew of unknowns regarding human nature, medical practice standards are not rigid like financial services and the application of medicine is highly individualized by physicians and patients. One the whole, healthcare imposes a significant demand that IT systems posses qualities such as flexibility, customizability and expandability.

Architecture Outline

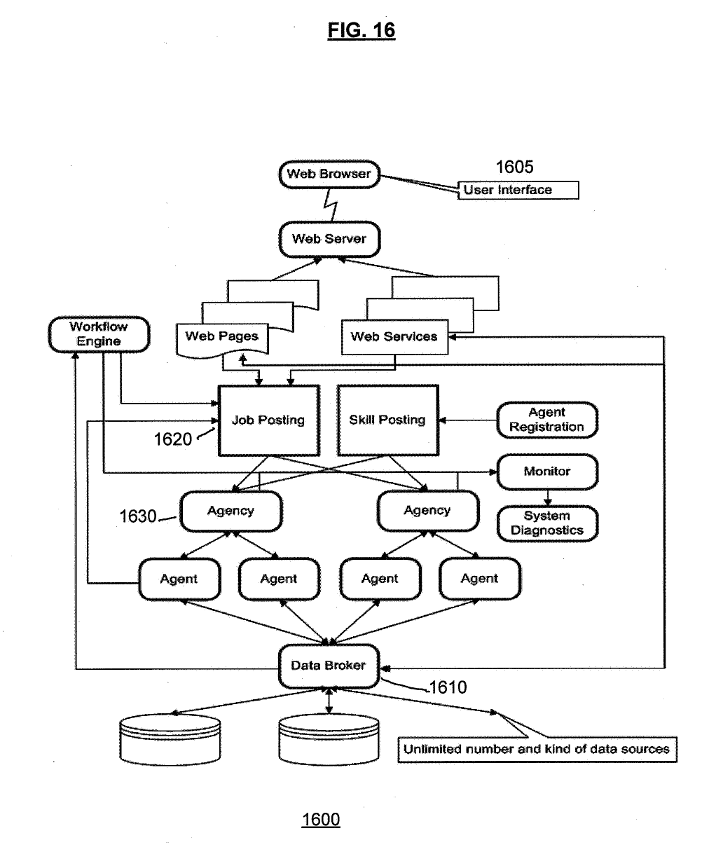

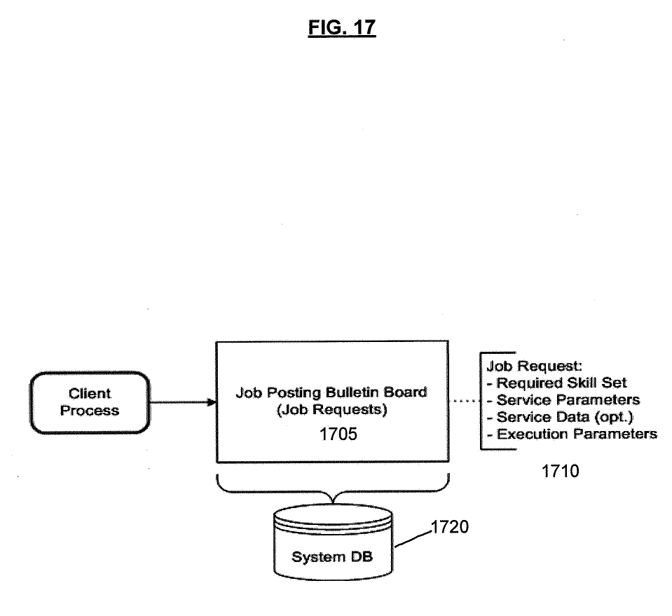

Various architecture models could be considered for applications with many ad hoc processes such as healthcare clinical workflow. However, the system architecture 1600 in FIG. 16 is more attractive due to its robustness, flexibility and expandability. End user presentation and interactivity is provided with thin client, web-based forms (1605) that create mini-applications to retrieve and store data using a data broker (1610). The data broker component entirely separates business logic of each form from the complexity of data. Requests for automatic services, such as printing, notification, case tracking, data archiving/de-archiving; multi-site synchronization, etc. are submitted via Job Posting (1620) (see FIG. 17 and Table 5, Job posting on a bulletin board).

To post a job, a web form or process creates a record on a Service Requests table a.k.a. “job posting bulletin board” (1705) with appropriate information (1710). The requested job can be performed by a system that can see the database (1720) and has an agency (1630) that handles a specific skill set.

Each job request contains “Job Description” which comprises two main elements: required skills (Service Type) and job properties (Service Parameters and Service Data or Content). Autonomic agencies manage agents (1810), which perform those jobs. Before an agent can perform its job it has to be registered. The registration consists of an agent invocation method and “skills” or ability to perform a specific job.

In addition to skill posting, each agent receives performance score (see Equation 1). The score is updated by the invoking agency after each execution. The score improves if the service is provided flawlessly and worsens if the service fails. An agency may assign another agent that has appropriate skill set if the first agent fails. After a few times the first agent may no longer be in preference to handle specific requests if its score diminishes below the score of a second agent.

$$Score = \frac{SuccessCount}{TotalCount} \qquad ( Equation 1 )$$

Each physical agent (program) may have multiple registrations as a service provider with different skills or different presets appropriate for different services. Each skill will be scored separately as the service is rendered and evaluated. Skill sets a.k.a. service types include but are not limited to (see Table 3):

TABLE 3
Example of Available Skill Sets

XML Print - 9 (1-15)
Archive - 17 (16-31)
De-archive - 18 (16-31)
HL7 Query - 33 (32-47)
FTP Query - 34 (32-47)
Email Import - 35 (32-47)
Web Query - 36 (32-47)
HL7 Export - 49 (48-63)
FTP Export - 50 (48-63)
Email Export - 51 (48-63)
HL7 Import - 55 (48-63)
FTP Import - 56 (48-63)
Email Import - 57 (48-63)
Transcript - 65 (64-79)
Work Handler - 81 (80-95)
Database Diagnostics - 97 (96-111)
Network Diagnostics - 98 (96-111)

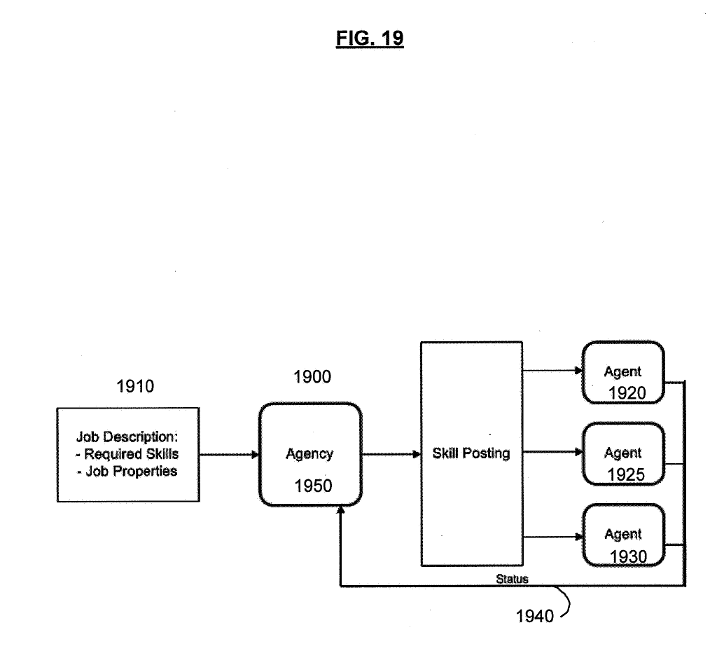

FIG. 19 is an illustration of an example job request handing structure recording to an embodiment of the present invention. An agency (1900) representing a specific specialty or ranges of skill sets takes all job requests (1910) for those ranges and matches required skills (see

Table 5) with posted skills (see Table 6) and assigns an agent (1920) to the job based on the match.

If more than one agent that represents the skill set is found the agent, which has a better score is assigned to the job. If two agents have the same score the first on the list is assigned. It could be the same physical agent but with different presets. This feature is very useful in rerouting tasks within unstable environment prone to frequent failures, e.g. network failures, random information hunting, military battlefields, etc.

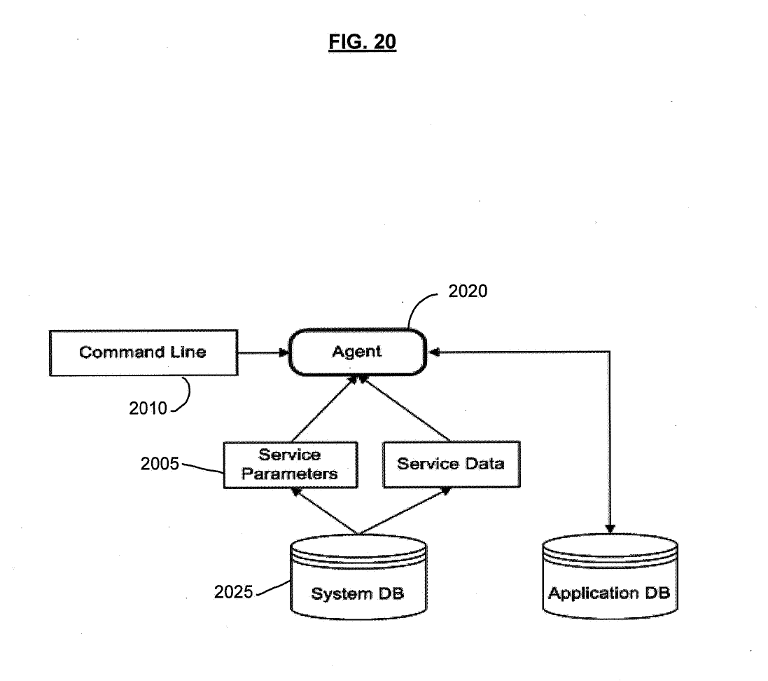

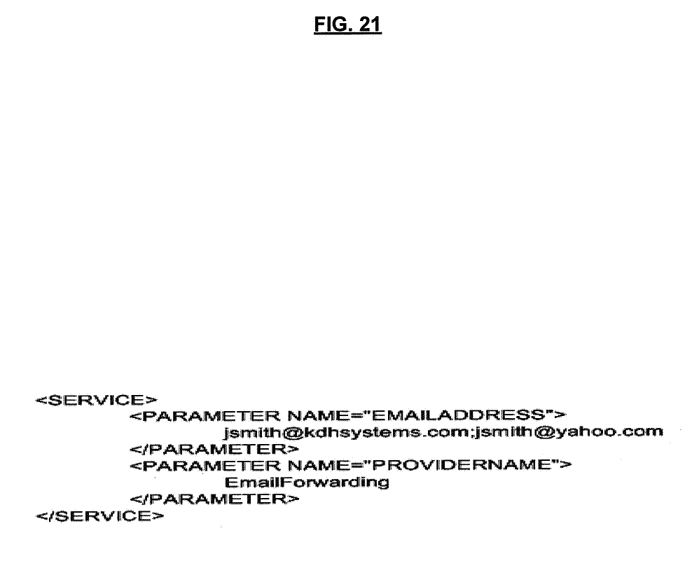

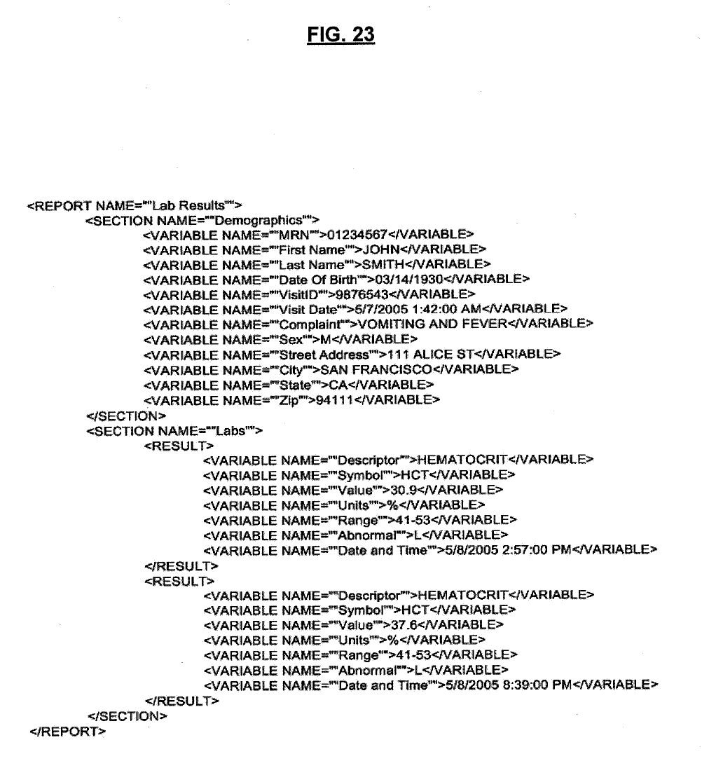

An agent (2000) assigned to a job retrieves job related properties (e.g., service parameters) and/or data (e.g. service data), performs the requested service and returns status to the invoking agency. For example, FIG. 21 provides an example of service parameters, FIG. 23 provides an example of service data, and FIG. 20 illustrates the invocation of an agent and an execution process. Service status can assume one of the following values (see Table 4 Examples of Status Values):

TABLE 4
Examples of Status Values

Unknown - 0
Waiting - 4
Completed - 16
Success - 32
Killed - 64
Failed - 128
In Progress - 256
Unavailable - 512
Unable to Perform - 1024

An agency can retry execution of a job request in case previous attempts were unsuccessful. Each process or job should have a limit on the number of re-executions to prevent zombie processes that are no longer useful.

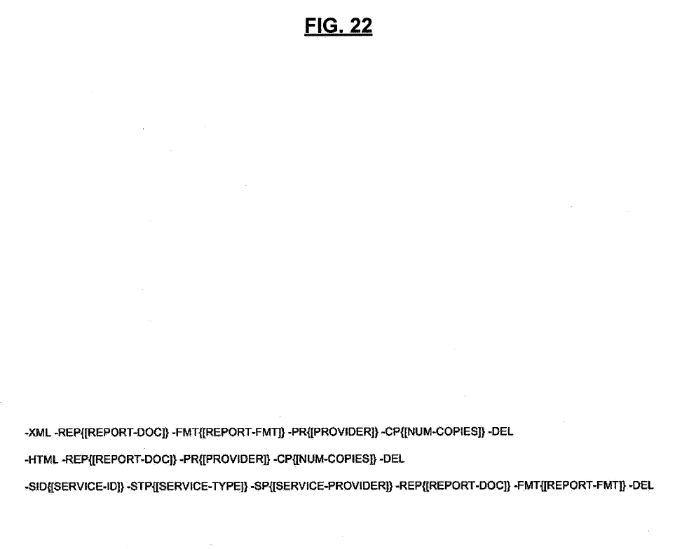

Service parameters are used to provide an agent with information necessary to perform the task. Some parameters can be passed on the command line but those should primarily be used to provide caller authentication, execution preferences and job ID based on which the agent can retrieve those parameters. For example, FIG. 20 provides an example invocation process that illustrates service parameters (2005) retrieved by the agent (2020) and command line (2010) passing only the data needed to retrieve the service parameters (2005) from the system database (2025). FIG. 21 is an example of service parameters, and FIG. 22 is an example of command lines.

Besides service parameters agents can receive service data within a job request record, e.g. print content, email content, etc. Both service parameters and service data should be stored as XML objects. The content of a service parameters object should conform to the requirements of a specific agent. Besides the agent service parameters have to be understood by the service requester, i.e. a web form or another process. The same principles apply to service data. Those two XML objects are not interpreted by agencies thus no requirement is imposed on that end.

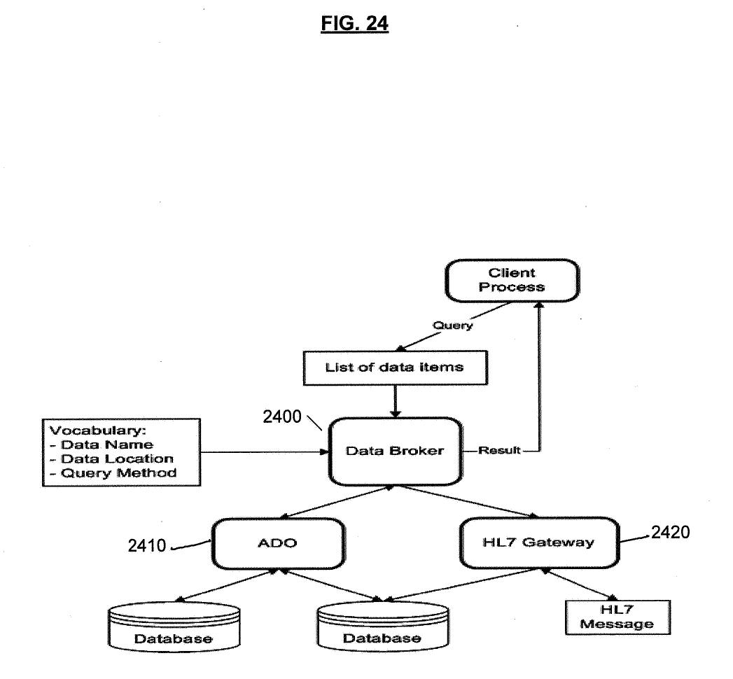

Agents and forms access the data layer (databases or other sources) with a data broker (2400) component, which isolates the clients from data storage complexity and provides additional flexibility in connecting to a variety of data repositories and sources such as SQL databases, HL7 systems, FTP servers, hardware sensors, etc. For example, FIG. 24 provides an example structure or connections between various sources including, for example ADO (2410), HL7 (2420).

The vocabulary (e.g., see Table 14) Data Broker Vocabulary is the economical way to configure installations without changing software code. In a new environment, instead of changing all programs and forms to match the fields and tables of databases a fuzzy match is applied to the existing data broker vocabulary and database schemas found in the environment. A fine tuning by a human operator may be required to ensure accuracy.

Vocabulary items are linked to queries that are used to retrieve or store those items. Before issuing a query, the data broker groups all vocabulary items connected to the same query to insure that each query is run only once per transaction.

The data broker supports three queries, such as retrieve, store and delete. An update query should be part of a store where a new record should be created if it doesn't exist or updated otherwise. In order to request a transaction on a set of data, the process specifies the request name (see Table 12, e.g., Query Reports list) patients, the list of vocabulary items to be obtained, e.g. Last Name, First Name, MRN, etc., the list of index values, e.g. From Date, To Date, etc. and optionally a site name. The following is an example of a request:
List Patients(Last Name, First Name, MRN) Where(From Date=‘2005/09/01’, To Date=‘2005/09/02’) On(Radiology)

The above request would extract a list of Last Name, First Name and MRN values from 2005/09/01 00:00 AM until 2005/09/02 24:00 PM from a system (remote site) registered as Radiology (e.g., see Table 11 Registration of remote sites).

If a system is not specified, a query on a local system is performed. A query on a remote site means that the query is passed to the remote system for its interpretation and application of local policies. A direct query of data stored on a remote system (server) is considered local. Both local and remote queries can be synchronous or asynchronous. Synchronous queries such as SQL return results to awaiting clients. Asynchronous queries such as HL7 do not return results but results are sent back and have to be retrieved separately. Asynchronous queries are more complicated to handle but provide the advantage of not locking up the client if the retrieval of data takes a significant time. The client can release resources and reactivate operation by an event indicating return of results.

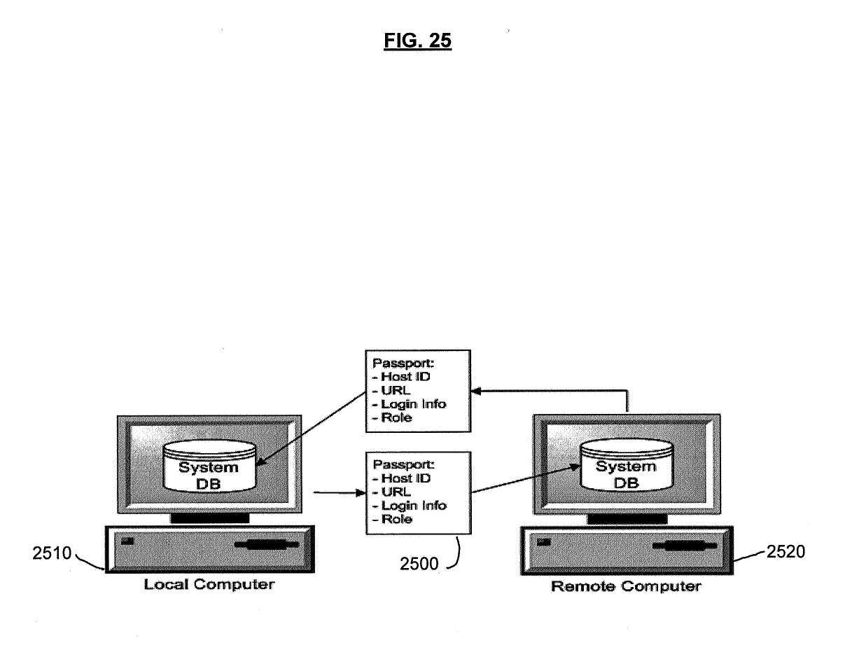

A remote vs. local query has the advantage of relieving a local system from complexity of a remote storage. In addition a remote system may use its own policies regarding data access and handling that may be very different than local policies. In order to enable remote queries both systems have to exchange passports that describe system location, access credentials and role. For example, FIG. 25 illustrates an example passport exchange between local and remote systems (e.g. local computer (2510) and remote computer (2520)). Each site can have multiple registration records or passports (2500) for different role IDs.

Besides providing services to agencies agents may also post new jobs on a bulletin board and set wait status for a specific job to be completed. After the job is completed the agency restarts the agent. One of the requests that agents may post are remote queries. When a remote query completes the awaiting agent gets re-invoked to complete its job.

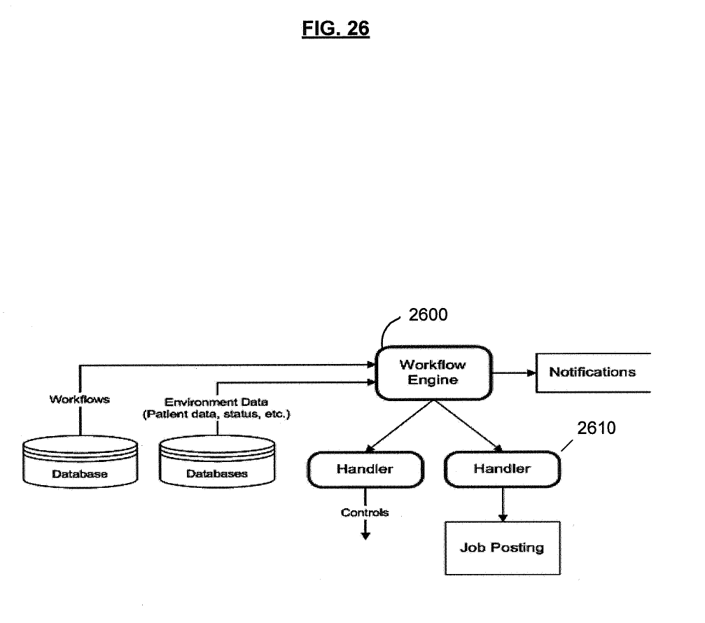

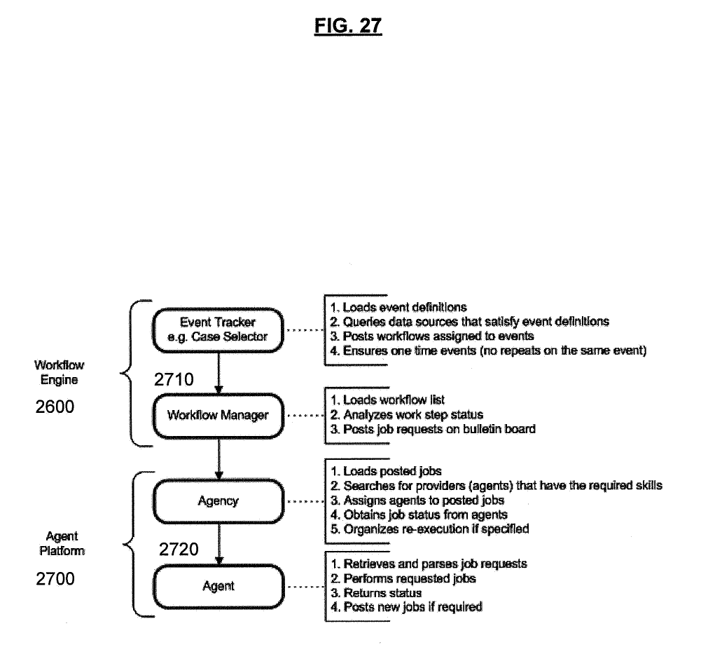

In one embodiment, there are three sources of job postings on a bulletin board: web pages, agents and workflow engine. The role of the workflow engine (2600) is to track events such as changes in data values, arrival of new data or actions, and responding to those events by calling handlers (2610) that may post jobs or perform requested operations directly. For example, FIG. 26 provides an example of a workflow engine (2600). The workflow engine (2600) comprises, for example, of two components: event tracker and workflow manager. For example, FIG. 27 illustrates a workflow process. The event tracker (2700) watches all data by issuing appropriate periodical queries to data repositories or responds to actions such as web requests to start a workflow or change of a work step status. Whenever any event happens a new workflow is started or a workflow engine invoked to analyze existing workflow conditions. The event tracker is also responsible to ensure that a specific event is detected only once, e.g. patient arrival is a one time event and related workflows are started only once.

Once a specific workflow is started, the control is taken by the workflow manager (2710), which responds to work step status changes or timeouts. Any change in a work step condition triggers a new action defined in a workflow definition. However, at any point of time a workflow can be terminated and redirected to another workflow to allow for ad hoc operations. In general, changes in data or user actions trigger new workflows or change work step status. Those changes in turn trigger workflow manager actions, which based on predefined workflow definition, activate agents (2720) to perform jobs. As shown in FIG. 27 an agent platform 2700 illustrates activated agents.

The workflow manager makes sure only one response to actions is performed. A single input and single output is performed via agents. An agent receives the property basket via a standardized interface. The agent proceeds to get data, process the data or other functions required, adds knowledge to the basket, and then passes the basket to the next component.

In one embodiment, intelligence (e.g., Artificial Intelligence (AI), rule based systems, fuzzy logic, neutral networks etc. and/or a combination of systems, e.g. a fuzzy expert system based on strict rules with fuzzy selection). which is implemented to change or alter workflow in progress (on-the-fly). For example, consider an ER response team that gathers new information about an emergency situation. As new information becomes available, the workflow changes to accommodate the new information. Use of AI or rule based systems to alter workflow on-the-fly is yet another example of self organization that may be accomplished with an architecture according to the present invention.

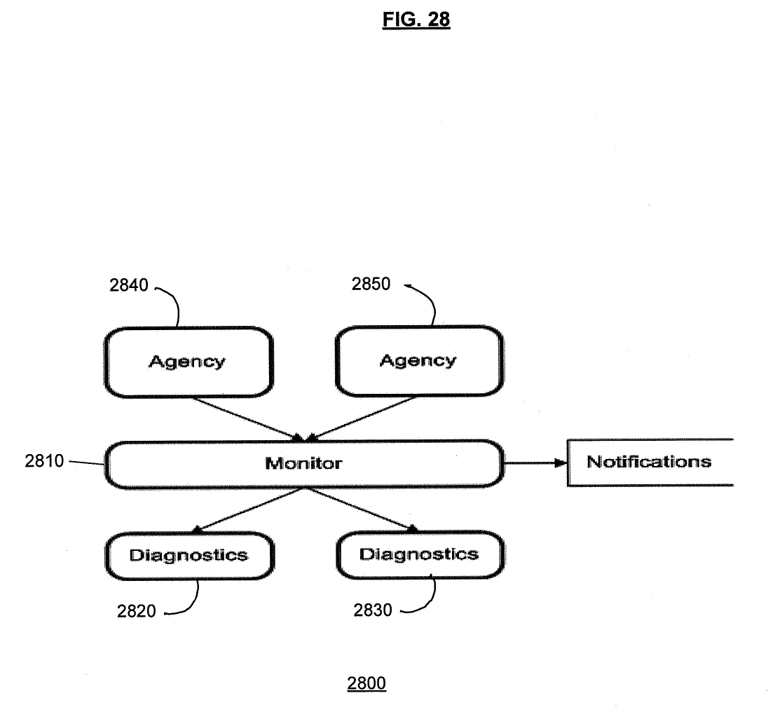

FIG. 28 illustrates a monitor (2810) which implements a monitoring service (2800). Quality control over the entire system is performed by the monitoring service, which analyzes status reports from each component. A workflow engine and agencies (2840/2850) report activity statistics such as time of action, time of successful service, errors, etc. A monitoring service (2810) tracks those reports and reacts accordingly, i.e. runs diagnostic programs (2820/2830) that test and fix systems problems, sends SMS messages and emails e.g. notifications to system administrators regarding system failures and recoveries, etc.

Bulletin Boards

In the heart of an agent platform there are two bulletin boards: job posting or service requests (see Table 5) and skill posting or service providers (see Table 6). The first bulletin board provides the means for clients such as web pages, workflow engine, agents, etc. to request agent services. The second bulletin board allows agents to advertise their services such as printing, data mining, data export/import, remote query, etc.

The three ID fields on the job posting bulletin board: Request ID, Requestor ID and Client System ID allow clients to identify whether they already posted a job request in response to certain conditions.

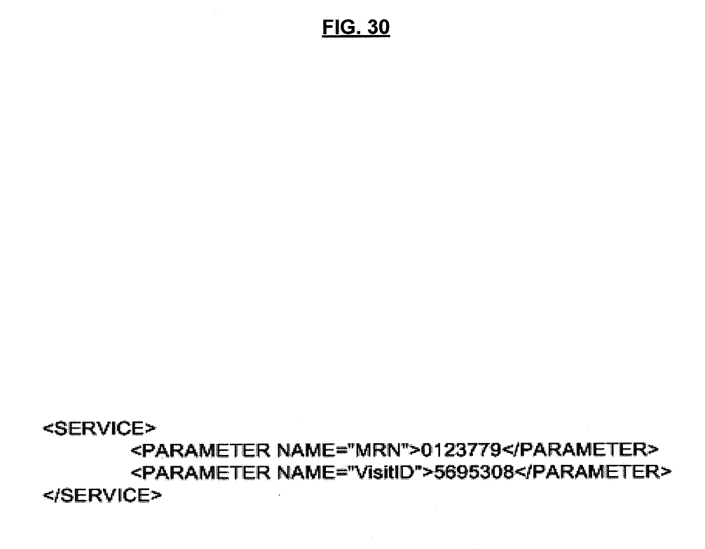

The Service Type field indicates the skills necessary to perform the job. The Source Name and Type fields identify the data repository the agent is expected to work with if the job requires such a reference. Service Parameters is a place where job description should be placed in the form of an XML document (e.g., see FIG. 30). The next two fields may contain service data. If the Location field is 1 the Content field contains data. If the Location field is 2 the Content field contains a path to a data file.

The following fields are to be used by the handling agency: Provider Name, Execution Date, Service Status and Process ID. The Provider Name field identifies the provider for a given Service Type. The Process ID field contains the operating system ID of a process representing an agent. The Repeats field is set by the requestor and then updated by an agency with each execution of an agent.

Job posting record contains two fields that are used to trigger events: WorkflowID and JobID. Whenever a status of job posting (Service Status) changes it signals to a workflow manager to re-evaluate the current work step of a WorkflowID workflow and decide what should be done next. The same change to finished state triggers re-execution of a JobID job.

TABLE 5
Job posting on a bulletin board

| | | |
|---|---|---|
| Service | integer | Record ID |
| RequestsID | | |
| Request ID | string | Unique ID of a specific request based |
| | | on data |
| Requestor ID | GUID | ID of a user or process that requested |
| | | the service |
| Client System | string | ID of a client system that requested |
| ID | | the service |
| Service Type | integer | Agent skill set ID |
| Request Date | Date/time | Date and time when the service was |
| | | requested |
| Source Name | string | The name of other data to be used by |
| | | the service |
| Source Type | integer | Type of a data source |
| Service | string | Parameters to be used by a service process |
| Parameters | | |
| Location | integer | Content: 1 - database field, 2 - file (path) |
| Content | string | Data to be used by a service process |
| Provider Name | string | Registration name of a service provider |
| Execution Date | Date/time | Date and time of an execution of a service |
| Execution ID | GUID | Unique ID used for return results |
| Service Status | integer | Posted, in progress, waiting, completed, etc. |
| Process ID | integer | Windows process ID |
| Repeats | integer | Number of times the service should be |
| | | repeated |
| Workflow ID | integer | Workflow ID under which job was requested |
| Job ID | integer | Job ID to run after completion |
| Active Member | bit | Indicator whether service is in progress of |
| | | finished |

In order to be visible to the system each agent must be registered on a skill posting bulletin board (see Table 6 Agent registration or skill posting bulletin board—Service Providers). There are five key items that have to be posted: Provider Name, Service Type, Service Parameters, Command Line and Process Path. The Provider Name field distinguishes a specific registration form the others. The Provider Name is primarily used for customization purposes, where specific registration of an agent is recommended. The next field named Service Type specifies the skill set or the ability to perform a specific task, e.g. FTP export, HL7 query, database diagnostics, etc. The following two fields: Service Parameters and Command Line specify execution attributes. The Command Line field provides information regarding caller credentials and access to environment, e.g. authorization code, job posting record ID, data file path, etc. The Service Parameters field stored as XML object specify job attributes, e.g. email address, encryption method, login credentials, etc. The fifth field Process Path allows agencies to find the binary to run it.

The Site ID field is optional and allows for registration of an agent physical location. The ID reference a site registration table (see Table 16 Registration of remote sites—Remote Sites). The Flags field tells the agency about specific behavior of an agent, e.g. singleton meaning that only a single copy of an agent can run at a time, etc. so further job requests to this agent should wait for the completion of a current job before the agent can be re-invoked.

The performance of an agent is recorded with two fields: Success Count and Total Count. The Success Count field is incremented whenever an agent completes the job successfully. The Total Count field is incremented on every execution of an agent.

TABLE 6
Agent registration or skill posting bulletin board - Service Providers

| | | |
|---|---|---|
| Provider Name | string | The name of a provider |
| | | (preconfigured agent) |
| Site ID | GUID | ID of a system site definition |
| Service Type | integer | Skill set |
| Service Parameters | string | XML document describing work |
| | | constants |
| Command Line | string | Command line parameter list with |
| | | variables |
| Process Path | string | File path to a process |
| NextProviderName (*) | string | The name of a provider to be invoked |
| Flags | integer | Process behavior flags |
| Success Count | integer | +1 on success |
| Total Count | integer | +1 on each execution |

(*) - For backwards compatibility

Workflow Engine

A Workflow Engine is a functional module that manages flow of work within a distributed system. The engine consists of two components: Event Tracker and Workflow Manager (e.g., see FIG. 27—Workflow process).

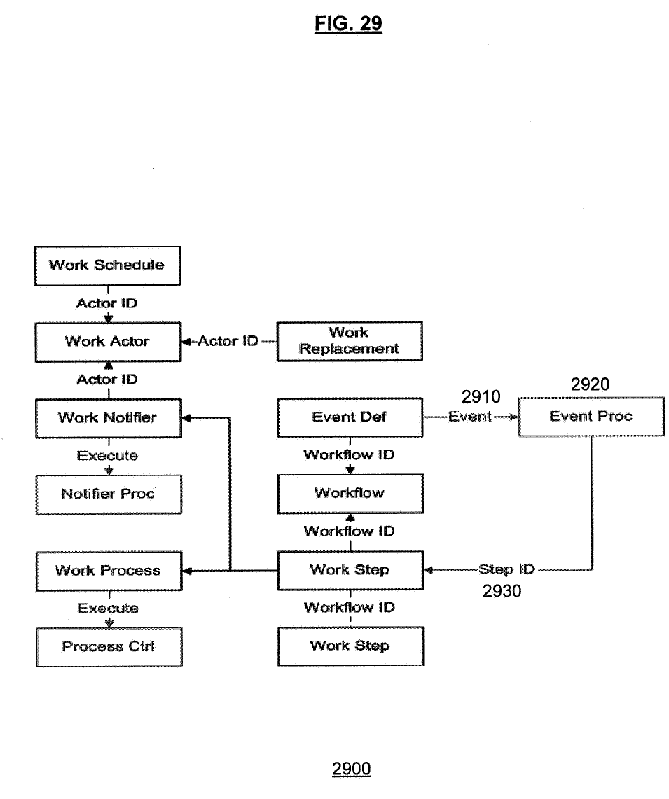

The Event Tracker component analyzes data based on event definitions and assigns workflows to those events for which criteria are satisfied. FIG. 29 provides an example of a workflow execution structure 2900) that may be utilized to analyze data (e.g., event proc 2920) and assign workflows (e.g., at workstep 2930). The step 1D is a starting workstep identified based on the Event (2910). Table 7 provides an exemplary list of Workflow events and Table 8 provides an exemplary list of Workflow events. The Workflow Manager oversees the execution of workflows, i.e. requesting notifications, executing tasks, checking conditions that trigger specific activities, etc. New workflows can be started in three ways:
When the Event Tracker finds an event definition for which data conditions are satisfied, e.g. patient arrival, abnormal lab results, form submission deadline passed, etc.—Which is a form of self-organization.
When the Workflow Manager finds a condition to branch an existing workflow, e.g. work step finished, exam ordered, etc.—Which is another form of self-organization.

In response to user (actor) activity such as submission of a specific form or selection of a specific menu item, e.g. signing of a report may trigger billing workflow, etc.

TABLE 7
Workflow events - EventDef

| | | |
|---|---|---|
| Event ID | GUID | |
| Event Name | string | |
| Creator ID | GUID | |
| Create Date | Date/time | |
| Updater ID | GUID | |
| Version Date | Date/time | |
| Condition | string | Condition that triggers the event: Query, |
| | | Stored procedure or Vocabulary formula |
| Case Keys | string | E.g. [MRN], [VisitID] |
| Accession | string | E.g. [SRC.MRN]-[SRC.VisitID]- |
| ID Format | | [WFW.EventID:G] |
| Workflow ID | GUID | Workflow that is executed when event |
| | | condition is true |
| Active Member | bit | |

TABLE 8
Workflow event process - EventProc

| | | |
|---|---|---|
| ID | GUID | ID of a workflow event instance |
| Event ID | GUID | |
| Step ID | GUID | Current step ID |
| Event Start Date | Date/time | Date and time at which event was |
| | | triggered |
| Step Start Date | Date/time | Date and time at which node was |
| | | entered |
| Step Run Date | Date/time | Date and time at which node should |
| | | be run again |
| Service Parameters | string | XML file with index values of an |
| (e.g., see FIG. 30) | | object/subject that triggered |
| | | the workflow event |
| Accession ID | string | ID calculated based on selected key IDs |
| | | and used to prevent duplication |
| | | of workflows |
| Step Status | integer | E.g. 0 - just created, 1 - in enter mode, |
| | | 2 - in run mode, 3 - in exit mode |
| Error Repeats | integer | |
| Exec Error | integer | |
| Active Member | bit | |

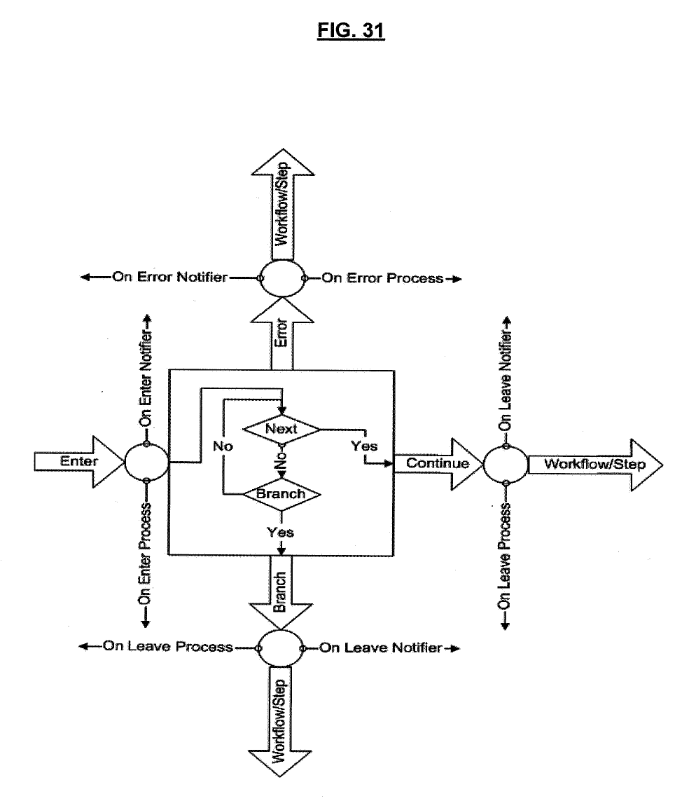

Workflow is defined as a chain of work steps. For example FIG. 31 illustrates details of a Workstep.

Each Workstep includes calculating conditional expressions such as, for example, environment data such as patient arrival, patient lab results, submission of a specific form, etc. and running appropriate tasks depending on those conditions. Table 11 provides an example of Workstep definition.

TABLE 9
Workflow definition - Workflow

| | | |
|---|---|---|
| Workflow ID | GUID | |
| Workflow Name | string | |
| Creator ID | GUID | |
| Create Date | Date/time | |
| Updater ID | GUID | |
| Version Date | Date/time | |
| Workflow URL | string | ftp://Host name or IP |
| Login Name | string | |
| Password | string | |
| Start Directory | string | Directory where workflow |
| | | status file is copied to |

Each workflow starts with a header an example of which is shown in Table 9, including for example, Workflow ID, workflow name, creator ID, etc., and is associated with or has attached a list of work steps. The workflow header contains information about the workflow author and the system that handles it, i.e. location (URL), login credentials (Login Name and Password) and a directory where workflow information is sent to. A file in that directory is loaded by an event tracker which starts a new local workflow based on that file. For local workflows, the system fields are empty.

Each workflow step consists of several operations. For example, Table 10 provides an example set of workflow steps, and FIG. 31 illustrates workflow step details.

TABLE 10
Workflow Steps
Step conditions calculations

On enter process and/or notifier
On leave process and/or notifier
On error process and/or notifier

Step conditions consist of two expressions one of which if true continues the thread and second branches if true. The second expression is calculated only if the first is false. If both are false the calculations resumed after a Repeat Interval expires (see Step Run Date in Table 8). The On Enter process and/or notifier are executed when the step is entered prior to checking any conditions. The On Leave process and/or notifier are executed when either of the conditions is satisfied and no error was encountered. The On Error process and/or notifier are executed when error is detected.

TABLE 11
Work step definition - WorkStep

| | | |
|---|---|---|
| Step ID | GUID | |
| Workflow ID | GUID | |
| Step Name | string | |
| Sequence | integer | |
| Creator ID | GUID | |
| Create Date | Date/time | |
| Updater ID | GUID | |
| Version Date | Date/time | |
| Start Date | string | Wait until start date and then run next condition |
| | | and branch condition - a list: May 3, Jun 4, 11/5, |
| | | etc. (month/day) |
| Next Condition | string | Condition to go to the next node (next in sequence) |
| Next Step ID | GUID | |
| Next Workflow ID | GUID | |
| Branch Condition | string | Condition to go to the branch node if next |
| | | condition failed |
| Branch Step ID | GUID | ID of a step on true result of a branch condition |
| Branch Workflow ID | GUID | or ID of a workflow on true result of a branch |
| | | condition |
| On Enter Notifier | string | |
| Condition | | |
| On Enter Notifier ID | GUID | Notifier ID to be sent when step is entered (prior to |
| | | step condition) and if enter condition is OK |
| On Enter Process | string | |
| Condition | | |
| On Enter Provider ID | GUID | ID of a process to be executed when step is entered |
| | | (prior to step condition) and if enter condition is |
| | | OK |
| On Enter Parameters | string | On Enter Process Service Parameters |
| On Leave Notifier | string | |
| Condition | | |
| On Leave Notifier ID | GUID | Notifier ID to be sent when after step condition is |
| | | satisfied and if leave condition is OK |
| On Leave Process | string | |
| Condition | | |
| On Leave Process ID | GUID | ID of a process to be executed after node condition |
| | | is satisfied and if leave condition is OK |
| On Leave Parameters | string | On Leave Process Service Parameters |
| On Error Notifier | string | |
| Condition | | |
| On Error Notifier ID | GUID | Notifier that is sent on error |
| On Error Process | string | |
| Condition | | |
| On Error Provider ID | GUID | Process that is run on error |
| On Error Parameters | string | On Error Process Service Parameters |
| Action On Error | integer | Continue or abort if node time out happens or other |
| | | error is detected |
| On Error Step ID | GUID | |
| On Error Workflow | GUID | |
| ID | | |
| Repeat Interval | string | Interval at which node condition is tested |
| Repeat Timeout | string | Repeat period after which error is reported and |
| | | workflow goes to error mod |
| Error Repeat Interval | string | |
| Error Repeats | integer | |
| Step Timeout | string | A time period after which workflow continues or |
| | | aborts |

Data Broker

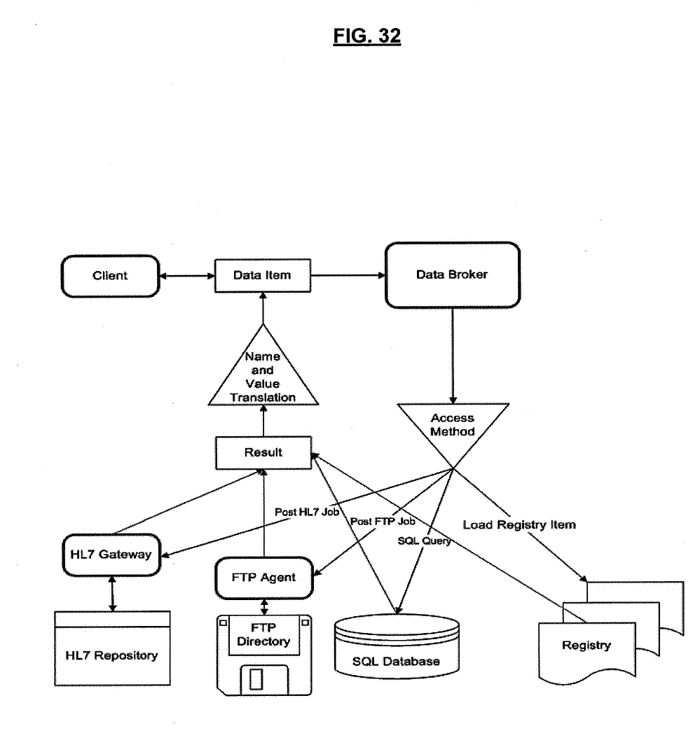

A Data Broker provides a unified access to all data available to the system whether local or remote. FIG. 32 illustrates an example data broker environment accordingly to an embodiment of the present invention. Each data item that is requested whether for reading or writing goes through vocabulary translation, which provides its physical name (see Vocabulary discussed below) and method of access (see Queries discussed below). Whenever a client needs to retrieve or store data it prepares a list of data items and a request (see Table 12). The data broker matches a query based on request name (Request ID) and data item name (Vocabulary ID) from a vocabulary query map (see Table 13). The same matching is performed for each data item, and then items represented by the same query are grouped to avoid repeating the same query.

TABLE 12
Query requests, e.g. Get Data, Store Data, etc. - Requests

| | | |
|---|---|---|
| ID | integer | |
| Name | string | The name or phrase representing query request |

TABLE 13
Connecting vocabulary to query request - Voc Query Map

| | |
|---|---|
| ID | integer |
| Vocabulary ID | integer |
| Request ID | integer |
| Query ID | integer |

Queries may require substitution of index values and other operations as explained in the Queries paragraph. Some queries return results right away but some require using agents so the response is no longer synchronous. However, each instance of a request obtains a unique ID, which can be used to re-request the data broker to see if the result already arrived. Arrival of a result may also trigger an event and call attached process or update workflow status.

Vocabulary

Vocabulary items are stored within a database table Vocabulary (see Table 14 Data broker vocabulary—Vocabulary). There are two ways of translating field names. Either by query aliasing or vocabulary input translation. An input translation can contain a single field name enclosed in brackets, e.g. [First_Name] that will be assigned to a vocabulary item First Name. In more complex situations an input translation can contain multiple fields or even a function, e.g. PtAge([DOB]) in which the vocabulary item Age will be calculated from the field DOB or date of birth. Those vocabulary items which input translations define more than a field reference cannot be used within store or delete queries.

TABLE 14
Data broker vocabulary - Vocabulary

| | | |
|---|---|---|
| Vocabulary ID | integer | |
| Creator ID | GUID | |
| Data Name | string | The name used by all applications |
| Data Source Name (*) | string | The name of a registry data object defining data |
| | | access |
| Data Type | string | S—String, B—Boolean, D—date, I—integer, F—float |
| Input Method (*) | integer | Direct - 0, SQL query - 1, Stored procedure - 2, |
| | | HL7 message - 3, FTP import - 4, Transcript - 5, |
| | | etc. |
| Input Translation | string | Conversion of a database field to vocabulary item |
| Input Query (*) | string | The name of a query that connects to the database |
| Version Date | date | The data when item was created or updated |
| Restriction | integer | 0 - none (clinical, research, financial, etc.), 1 - |
| | | clinical, 2 - financial, 4 - admin |
| Active Member | bit | |

(*) Provided for backwards compatibility

Queries

Queries are stored within a database table Queries (see Table 15 Vocabulary queries—Queries). There are a number of methods to query data. The simplest method is a call to a stored procedure:

PROC PatientDemographics(ptMRN={[MRN]}).

In the above example the keyword PROC specifies the stored procedure to be called which name is PatientDemographics. The procedure requires one parameter ptMRN which value comes from the stock item (result of previous query) named MRN. Strings representing values are enclosed in {[ ]} brackets. A more complex query is shown below:

VAR PersonallID=FirstNotEmpty({[DocID]}, {[AttendingID]}) FROM PROC {[FormName]}Form(ptMRN={[MRN]}, visID={[VisitID]});

OUT Decode({[FirstName]}, {[LastName]}, {[PersonalID<ENC>]}) FROM PROC UserAccountsDB::UserInfo([UserID<ENC>]={[PersonalID]});

If a query expression contains more than one query each query but last has to be terminated with a semicolon (;). The keyword VAR specifies a variable, in this case PersonalID, which value is obtained from a non-empty field DocID or AttendingID. The fields are obtained from a stored procedure call and then run through the FirstNotEmpty function to find the non-empty value. The name of a stored procedure is combined from a stock item FormName and the word Form. The procedure requires two parameters: ptMRN and visID. The values of those parameters come from stock items MRN and VisitID respectively. The keyword OUT specifies a query output which is the result of decoding the fields FirstName, LastName and PersonalID (field not variable). The first two are not modified while PersonalID is decrypted prior to returning the result. The values of FirstName and LastName are obtained as a result of a stored procedure UserInfo run on UserAccountsDB database. The procedure takes on parameter UserID, which is an encryption of PersonalID variable. Query can also be run on other sources such as system registry or file as shown below:

OUT ClinicName={[SiteName]} FROM REG {[PubRegistryPath]}\System;

OUT ClinicAddress={[ClinicAddr]} FROM FILE

{[SystemFolderPath]}\SiteData\SiteInfo.txt;

In the example above two values are returned: ClinicName and ClinicAddress. ClinicName is obtained by reading a path PubRegistryPath\System\SiteName while ClinicAddress is obtained by reading ClinicAddr value from a file SystemFolderPath\SiteData\SiteInfo.txt. The file contains items defined as follows:

ClinicAddress=12 Alice St., San Francisco, Calif. 941234

ClinicPhone=(111) 123-4567 etc.

Besides stored procedures SQL queries can also be used, e.g.:

QRY SELECT DOB, Addr, Home_Tel FROM Demographics WHERE MRN={[MRN]};

The above query defines SQL query SELECT which retrieves three fields DOB, Addr and Home_Tel. The condition for extraction is a stock item MRN.

TABLE 15
Vocabulary queries - Queries

| | | |
|---|---|---|
| Query ID | integer | |
| Query Name | string | Unique name used by vocabulary |
| Query Args | string | List of query arguments separated with “,” to be |
| | | provided to run the query |
| Reg Index | string | E.g. ID = GUID( ); Reg ID:G = [ID] or just Reg |
| | | ID: I = [ID] if ID is AutoNumber, Study |
| | | ID = [VAR.main ID] |
| Data Source | string | The name of a registry data object defining data |
| | | access |
| Direction | integer | 0, 1 - Retrieve; 2 - Store; 3 - Delete |
| Service Type | integer | 0 - direct query; 34 - FTP query; 97 - HL7 query |
| Location | integer | 1 - Field, 2 - File |
| Content | string | SQL with {[ ]} for setting values, HL7 message |
| | | with {[ ]} for setting values, etc. |
| Version Date | date | |

Remote Sites

A remote site is the system that complies with different rules, uses separate agent platform and which resources are not directly available on the intranet. In order to access its resources other systems must send requests for queries, job outsourcing or workflow activations. Before the site can be used it is registered. Table 15 provides an example list of remote system registration, and FIG. 25 illustrates an example passport exchange between local and remote systems. A Service Type is the list of services that are allowed to be performed for a specific Role ID. The Host ID represents host name and MAC address of a specific system. The URL field contains information about the connection method and address, e.g. http://site/page or ftp://IPaddress, etc. The field Login Info contains full information (encrypted) about login credentials.

TABLE 16
Registration of remote sites - Remote Sites

| | | |
|---|---|---|
| ID | GUID | |
| Name | string | Registration name of a site |
| Service Type | string | Types of services the site can provide (all if |
| | | empty) |
| Host ID | string | Site host ID used for authentication |
| URL | string | Site location |
| Login Info | string | Site login credentials |
| Role ID | string | Site login role ID |
| Active Member | bit | |

Agency

An agency is a specialized agent that manages other agents. An example agency 1900 is illustrated in FIG. 19. The main role of an agency is to retrieve jobs posted on a bulletin board that are relevant to its specialty and match agent skill to those jobs. Once skills are matched, the agency can call an agent and pass it the job. Once an agent is deployed, the agency waits for the status whether completion, failure or temporary termination. Agents that become silent i.e. do not send status information for extended periods of time are killed instantaneously. Some agencies may do some preparation work before calling an agent such as copying files, testing environment, etc.

Agent

Agents are programs that perform allocated jobs. They read and interpret requests (Service Parameters—communication), analyze data, make decisions related to the requested job and perform the job. Agents may also request other agents to provide services to them. Since the jobs are performed in the background agents must be equipped with sophisticated reasoning methods of thorough decision process to successfully perform tasks in various situations. Simple methods similar to user driven applications will likely fail due to lack of that interaction.

Scoring is maintained with respect to how well agents work. Agents that eventually go to little or no value are removed. For example, an agent that is scored zero indicates that the agent was used but failed or was highly inefficient compared to other agents and is a candidate for removal.

System Services

The system provides two types of services: continuous and on demand. Continuous service is provided by independent software agents such as HL7 gateway or case selection. Those services continuously listen to ports or scan databases and respond according to their roles. Services on demand are provided through requests posted on a bulletin board. The following are the groups of services that the system provides:

a. HL7 Gateway
HL7 Gateway provides continuous reception of HL7 broadcasts and on demand HL7 message dispatch. Broadcasted messages are sent to a HL7 receiver, which stores them into a buffer. Buffered messages are processed by a HL7 parser, which extracts data items from HL7 messages and puts them into a cache database. The HL7 receiver can listen to multiple ports but also a single port can handle multiple sources of messages.

b. DICOM Gateway

c. Data Import/Export

d. Voice Dictation and Transcription

e. Natural Language Reporting

f Printing

System services depend on a system database. Examples of these data base tables are show in Tables 17 through 25.

TABLE 17
Service Clients

| | | |
|---|---|---|
| ID | integer | |
| Client System ID | string | Client (workstation) ID |
| Specialty | string | Group of application, e.g. cardiology, |
| | | oncology |
| Form Name | string | Web form name to be serviced by a provider |
| Group ID | integer | Form group ID (report, chart, etc.) |
| Service Type | integer | Skill set |
| Provider Name | string | The name of a service provider |
| Active Member | bit | |

TABLE 18
Remote Queries

| | |
|---|---|
| ID | integer |
| Query Type | integer |
| Request Date | date |
| Client | string |
| Role ID | string |
| Location | integer |
| Content | string |
| Active Member | bit |

TABLE 19
Notifiers

| | |
|---|---|
| Notifier ID | GUID |
| Account ID | GUID |
| User Name | string |
| Institution | string |
| Department | string |
| Access URL | string |
| Subject | string |
| Message | string |
| Query List | string |
| Search Expression | string |
| Source Name | string |
| From Name | string |
| Listing Color | string |
| Set Case Status | bit |
| Search Form | bit |
| Monitor | bit |
| Service Type | integer |
| Provider Name | string |
| Repeats | integer |
| Repeat Interval | integer |
| Active Member | bit |

TABLE 20
Notifier Requests

| | |
|---|---|
| Transaction ID | integer |
| Request ID | string |
| Requestor ID | GUID |
| Notifier ID | GUID |
| Request Date | date |
| Source Name | string |
| Form Name | string |
| Search Form | bit |
| Access URL | string |
| Subject | string |
| Message | string |
| Service Type | integer |
| Provider Name | string |
| Repeats | integer |
| Repeat Interval | integer |
| Repeat Time | date |
| Listing Color | string |
| Set Case Status | bit |
| Cancel | bit |
| Active Member | bit |

TABLE 21
List Query

| | |
|---|---|
| Query ID | integer |
| App Name | string |
| Form Name | string |
| List Name | string |
| List Type | integer |
| Access Code | integer |
| Time Range | string |
| Src DB Name | string |
| Src Query | string |
| Sort Command | string |
| Frm Reg DB Name | string |
| Frm Reg Query | string |
| Case Sel DB Name | string |
| Case Sel Query | string |
| List Functions | string |
| List ID Def | string |
| List Status | string |
| Page Name | string |
| Encoding | string |
| Page Date | date |
| Content | string |
| Active Member | bit |

TABLE 22
Form Cache

| | |
|---|---|
| ID | integer |
| User ID | GUID |
| Form ID | string |
| Form Name | string |
| Page Name | string |
| Location | integer |
| Content | string |
| Date | date |

TABLE 23
Case Status

| | |
|---|---|
| ID | integer |
| MRN | string |
| Visit ID | string |
| Date | date |
| Service Type | integer |
| Status | integer |
| Listing Color | string |
| Mode | integer |

TABLE 24
HL7 Messages

| | |
|---|---|
| ID | integer |
| Name | string |
| Query List | string |
| Location | integer |
| Content | string |

TABLE 25
Report filters - Filters

| | | |
|---|---|---|
| Filter ID | integer | |
| Filter Keyword | string | Phrase |
| Keyword Type | integer | 0 - word, 1 - prefix, 2 - suffix, |
| | | 3 - any part of word |
| Location | integer | 1 - Field, 2 - File |
| Content | string | Filtering formula or file name |
| Version Date | date | |

Monitor

In order to provide a reliable operation the system needs to be monitored for failures or problems that may turn into failures. A detection of problem is not enough to ensure unattended operation. The system has to be able to fix itself. As illustrated in FIG. 28, a system monitor 2810 includes diagnostics (2820) and (2830) for detection of issues to be fixed. The issues to be fixed may themselves be posted as a job for the best suited agent (e.g., via an agency such as Agency (2840) or (2850)) to repair.

Fuzzy Search

This algorithm describes the search of a pattern string within another string where not all characters of a pattern are represented in the search string and vice versa, e.g. the word LastName matches LstName or Last Name strings though the match is less than 100%. In the algorithm the positions of each pattern character are found within the search string and then iterated through to ensure the same order as in the pattern. For each iteration, the probability of match is calculated as follows:
Sum the inverses of distance between all consecutive characters in the word, e.g. if the characters are next to each other the value is 1, if they are separated by a character that is not present in the pattern the value is 0.5, if two characters separate those in consideration the value is ⅓, etc.
Divide the total by the number of characters minus one
Find all matches that fall above the threshold
   Some techniques can be applied to reduce the number of iterations, e.g. position of the character that starts the match within the pattern, maximum distance between two consecutive characters in a match, etc.
   Use Cases of a Screen Form Filler

In order to illustrate the most important features of the architecture and roles if its services a few cases representing some of the applications will be presented.

1. ED Patient Visit
The patient arrives at an Emergency Department. The patient is conscious and registers with a front desk clerk. The clerk asks some of the demographics information and the reason of a visit (complaint). The patient informs the clerk that he has a health passport with KDH. The clerk asks for an ID and a health care provider password that the patient created before. A card with magnetic strip can be used in place of typing. The KDH screen form filler prompts the clerk to put a cursor in a designated field and then hit the control key. When the clerk hits the control key the KDH screen form filler populates the registration form with whatever information is available.

b. Outpatient/Inpatient Visit
The patient calls a GI clinic to schedule his/her visit. This is the first visit so the patient doesn't have a record yet. The clerk asks some demographics questions and negotiates the visit date and time. The clerk also asks the patient to create a health passport with KDH web site if he/she hasn't done it before and fill out a visit form for a given ID. The patient logs into a KDH web site, types an ID and an empty form opens. If the patient already had a passport the form could contain some of the information from his/her passport. The patient types in the required data including the give away (one time) password and submits the form. The system turns the password into an encryption key, creates and encrypts a XML document and stores it in a database. On the day of a visit the patient arrives at the front desk of an outpatient facility of a GI clinic. The clerk opens the registration form, e.g. on Epic system and then selects the patient from a KDH screen form filler. The KDH screen form filler downloads patients for a specific date who have specific forms filled out. The screen form filler prompts the clerk to type the one time password and then to put the cursor into a designated field and then hit the control key on a keyboard. In response to the control key the screen form filler populates the fields. If the form needs multiple screens the process repeats without asking for the password.

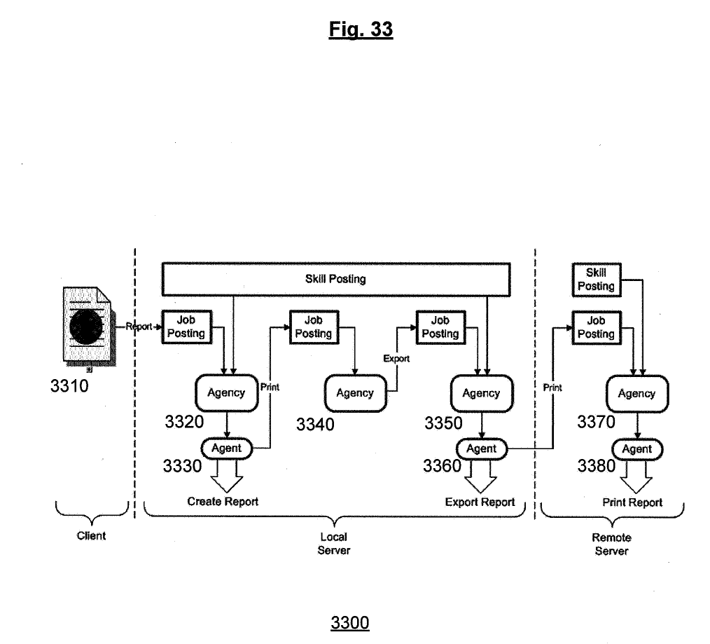

FIG. 33 is a flow chart illustrating an example agent workflow process (3300) according to an embodiment of the present invention. Steps of the process are labeled 1-8 and include:

Step 1: (3310) a user presses a submit button on a web form. The form stores collected data to a database and creates a job request to generate a report with assigned agent workflow that extends report generation with printing. The job request is posted on a job request bulletin board.

Step 2: (3320) An agency specializing in reports finds a job request, matches it with the highest scoring skill posting regarding report creation and invokes the relevant agent.

Step 3: (3330) An agent takes the job request or job description basket, finds appropriate data based on that description, creates a report and saves it back to a database. Before finishing, the reporting agent consults with a workflow table to see if there is a link to a next agent. In this case, there is a link to a print skill. The agent adds information about created report into a job request and posts it on a job request bulletin board.

Step 4: (3340) An agency specializing in printing finds the job request and checks the original client system that requested this workflow to run. It finds from a client table that a remote server is appointed to perform the print. The agency reposts the request as a print export job request.

Step 5: (3350) An agency specializing in import/export finds the request and matches it with the highest scoring skill posting regarding data export and invokes the relevant agent.

Step 6: (3360) The export agent loads the job description basket, finds the print server and using upload web service on a remote machine delivers the print file. The web service also posts a print job request on a remote machine. The workflow completes at this step on a local machine.

Step 7: (3370) An agency specializing in printing checks the original client system and finds from a client table that the print process belongs to this machine. It matches the job request with the best scoring skill posting and invokes the relevant agent.

Step 8: (3380) The print agent takes the job description from a job request bulletin board, performs the job and completes the workflow on a remote machine.

Many other example processes will be apparent in nearly all areas of information and process management upon review of the present disclosure. Although the present invention is mainly described in terms of workflow and an architecture to be used in the medical industry, nothing herein should be construed as to limit the present invention to the medical industry (e.g., healthcare or physicians and hospitals, etc.). Useful benefits from the present invention are available everywhere companies are trying to improve IT services with service oriented architectures or similar technology (including, but not limited to those known as, for example, ESB—enterprise service bus, ECM—enterprise content management, SBV—shared business vocabulary, EII—enterprise information integration, MDM—master data management, and BPM—business process management, that are all about changing business and IT behaviors.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, and the display, storage, or communication of results according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that, within the scope of the appended claims, the invention may be practiced otherwise than as specifically described herein.

What is claimed and desired to be secured by Letters Patent of the United States is:

1. An architecture for applications, comprising:
a set of building blocks wherein each building block comprises a component with a single standardized interface;
a set of agents that operate independently of each other agent,
wherein the building block components and agents are not arranged in either client-server or master-slave relationships, but instead are at a peer level to each other.

2. The architecture according to claim 1, wherein the single standardized interface comprises a property basket containing only properties.

3. The architecture according to claim 1, wherein each component interface is configured to transfer knowledge, and each component is configured to retrieve data as needed to implement functionality of the component.

4. The architecture according to claim 3, wherein the retrieved data comprises all of the data needed to implement the functionality of the component.

5. The architecture according to claim 3, wherein the data needed to implement the functionality of the component is retrieved independently of the interface.

6. The architecture according to claim 3, wherein the knowledge transferred via the interface comprises non-data elements.

7. The architecture according to claim 3, wherein the knowledge transferred via the interface comprises a workbasket comprising properties of a job.

8. The architecture according to claim 3, wherein the knowledge transferred via the interface comprises a workbasket comprising proprietary formatted properties of a form.

9. The architecture according to claim 1, further comprising a workflow engine configured to track events such as changes in data values, arrival of new data or actions, and responding to those events by calling a handler or posting a job request.

10. The architecture according to claim 9, wherein the handler comprises an agent configured to post jobs or perform requested operations directly.

11. The architecture according to claim 9, wherein the workflow engine comprises an event tracker configured to watch data by issuing periodical queries to data repositories and workflow manager configured to respond to actions by analyzing workflow conditions and start a workflow or change of a work step status.

12. The architecture according to claim 11, wherein the workflow manager makes sure only one response to actions is performed.

13. The architecture according to claim 11, wherein the workflow manager utilizes a series of single input, single output agents to respond to actions, and the single input and single output of the agents is a property basket passed from agent to agent.

14. The architecture according to claim 13, wherein the architecture is self-organizing.

15. The architecture according to claim 14 wherein the self-organization alters work flow in progress.

16. The architecture according to claim 15 wherein the self organization is based on one of a rule based, fuzzy expert system.

17. The architecture according to claim 10, wherein actions to be responded to include web requests.

18. A method for job completion, comprising:
posting a job request on a bulletin board;
posting job skills on the bulletin board; and
matching each job request with one of a component and/or agent having posted skills best matched to the job request.

19. The method according to claim 18, wherein the posted job request originates from at least one of a form, an agent, and a component.

20. The method according to claim 18, further comprising the step of actively monitoring the bulletin board for job postings and calling agents best matched to the job request.

21. The method according to claim 20, wherein the best matched agent has the highest score for performing the job.

22. The method according to claim 21, wherein the highest score is determined by at least one of accuracy, speed, footprint size, and cost of performing the job by a qualified agent.

23. The method according to claim 18, wherein each job request contains “Job Description” which comprises each of required skills (Service Type) and job properties (Service Parameters and Service Data or Content).

24. The method according to claim 18, wherein:
said method is embodied in a set of computer instructions stored on a computer readable media;
said computer instructions, when loaded into a computer, cause the computer to perform the steps of said method.

25. The method according to claim 18, wherein said computer instruction are compiled computer instructions stored as an executable program on said computer readable media.

26. The method according to claim 18, wherein said method is embodied in a set of computer readable instructions stored in an electronic signal.

27. A goal oriented architecture that provides workflow configurations and workflow solutions on-the-fly, comprising:
a set of peer level processes, including,
agents for coordinating tasks,
components for executing specific functions, and
forms for displaying and linking data related to a specific task,
wherein each peer level process is a compete application having a single standardized interface;
a data repository configured to maintain all data utilized in the forms, tasks, or required for processing component functionalities; and
a bulletin board configured to be the sole link between the agents, components, and forms;
wherein the single standardized interface is configured to transfer knowledge, and each peer-level process is configured to retrieve data as needed to implement functionality of the process from the data repository.

28. The architecture according to claim 27, wherein at least one agent includes multiple registrations as a service provider with different skills or different presets appropriate for different services, wherein each skill is scored separately as the service is rendered and evaluated.

29. The architecture according to claim 27, wherein the forms comprises at least one of logging forms utilized as entry points to virtual applications, menu forms that are registered entries to physical applications, Listings forms configured to be used by menu forms to list items prior to entering a specific physical application, general forms configured for administration, research forms configured for one of data collection, data mining, and data management.

30. The architecture according to claim 27, wherein the peer level processes, data repository, and bulletin board interact to implement a process to,
collect data form a user submitted form,
store the collected data in the data repository,
post a job request on the bulletin board,
match an agency comprising one of a broker and workflow manager with the posted job request;
wherein the agency invoices an appropriate agent or other agencies for performing tasks associated with the user submitted form.

31. The architecture according to claim 30, wherein the appropriate agent or other agencies for performing tasks associated with the user submitted form include
an agent configured to utilize the job request and an associated job description basket to retrieve data from the data repository, process the retrieved data, and store the processes data back into the data repository.

32. The architecture according to claim 31, wherein the tasks associated with the user submitted form composes a report to be printed.

33. The architecture according to claim 31, wherein said other agencies comprise agencies specialized in import/export and printing.
